(19) United States
(12) Patent Application Publication
(10) Pub. No.: US 2006/0133786 A1
(43) Pub. Date: Jun. 22, 2006

(54) Driving mechanism, driving system, anti-shake unit, and image sensing apparatus

(75) Inventor: Tougo Teramoto, Wakayama-shi (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/210,935

(22) Filed: Aug. 24, 2005

(30) Foreign Application Priority Data
Dec. 17, 2004 (JP) 2004-365894

(51) Int. Cl. G03B 17/00

(52) U.S. Cl. 396/55

(57) ABSTRACT

A driving mechanism includes: a fixed base member; a movable base member which is moved relative to the fixed base member; and at least three driving devices each having an operating part which is moved linearly, wherein the three driving devices are loaded on either one of the fixed base member and the movable base member, at least three operated parts are formed on the other one of the fixed base member and the movable base member where the driving devices are not loaded, driving forces from the operating parts of the driving devices are acted on the at least three operated parts, respectively. The operated parts each has a moving guide part extending in a direction of a guide axis orthogonal a linear driving axis along which the corresponding operating part of the driving device is moved. The operating parts are guided in the respective corresponding moving guide parts to cause relative rotation of one of the movable base member and the fixed base member against the other. At least one of the linear driving axes extends in a first direction, the other linear driving axis extends in a second direction orthogonal to the first direction, and the respective linear driving axes extend in tangential directions of a circle having an arbitrary point on the movable base member or the fixed base member as a center point. The respective guide axes extend in radial directions with respect to the center point

This application is based on Japanese Patent Application No. 2004-365894 filed on Dec. 17, 2004, the contents of which are hereby incorporated by reference.

### BACKGROUND OF THE INVENTION

1. Field of the Invention

The present invention relates to a driving mechanism and a driving system that enable to move a movable base member relative to a fixed base member in its rotating direction, as well as in two axis directions, and to an anti-shake unit particularly adapted for correcting shake in a digital still camera, a digital video camera, or a like apparatus incorporated with the driving mechanism and the driving system, and to an image sensing apparatus loaded with the anti-shake unit.

2. Description of the Related Art

In image sensing apparatuses such as a digital still camera and a digital video camera, there is known an anti-shake mechanism of swinging an image sensor such as a CCD (charge coupled device) sensor, as disclosed in Japanese Unexamined Patent Publication No. 2003-110929, as an example of an active anti-shake mechanism of swinging part or entirety of an optical system to correct misalignment of an optical axis of the optical system arising from a shake of the camera or the like. The anti-shake mechanism of swinging the image sensor (CCD-shift type anti-shake mechanism) makes it possible to realize a compact and high-resolution-adaptive anti-shake mechanism because a lens dedicatedly used for shake correction is not necessary. In such an anti-shake mechanism, generally, a driving force for swinging the image sensor in two axis directions perpendicular to the optical axis (x-axis direction and y-axis direction, or pitch direction and yaw direction) is applied to the image sensor by a driving mechanism such as a piezoelectric actuator disposed on a side portion of the image sensor.

In the above anti-shake mechanism of swinging the image sensor, there has not been proposed an anti-shake mechanism capable of rotating an image sensor around an optical axis (in θ-direction or rolling direction), as well as in two axis directions perpendicular to the optical axis for shake correction. Therefore, if an external force accompanying rotation is exerted to the camera, appropriate shake correction to cancel such a movement cannot be performed.

Japanese Unexamined Patent Publication No. 2000-187256 discloses, an exemplary anti-shake mechanism for use in a film camera (so-called silver halide camera), which makes it possible to perform θ-direction driving, as well as the aforementioned x-axis and y-axis direction driving for shake correction. In the mechanism disclosed in the publication, driving in x-axis direction and driving in y-axis direction for shake correction are secured by a lens dedicatedly used for shake correction, and driving in θ-direction is performed by employing an actuator made of a shape-memory alloy. Since this arrangement requires two driving systems for shake correction, the arrangement fails to provide a miniaturized and lightweight mechanism.

In the anti-shake mechanism of swinging the image sensor, it is possible to execute the θ-direction driving for shake correction in addition to the x-axis and y-axis direction driving for shake correction by pivotally supporting, on another base member, a base member loaded with a driving mechanism for the x-axis and y-axis driving for shake correction. In such a construction, at least two base members are necessary in addition to a movable base member loaded with the image sensor, and these base members are required to be placed one over the other. Such an arrangement may increase the thickness of the mechanism, and may increase the weight thereof by the weight corresponding to the increased number of base members.

### SUMMARY OF THE INVENTION

It is an object of the present invention to provide a driving technology which has overcome the problems residing in the prior art.

It is another object of the present invention to provide a driving mechanism and a driving system which can execute driving in θ-direction, which is a direction of rotating a movable base member around an axis of rotation thereof as well as driving in x-axis direction and driving in y-axis direction, along which parallel movements of the movable base member are executed.

It is still another object of the present invention to provide a compact image sensing apparatus which is equipped with an anti-shake mechanism of moving an image sensor in a rolling direction, as well as in pitch and yaw directions.

According to an aspect of the invention, there are at least three driving devices each of which has an operating part movable linearly, and which are loaded on either one of a fixed base member and a movable base member movable relative to the fixed member. At least three operated parts are formed on the other one of the fixed base member and the movable base member where the driving devices are not loaded to receive driving forces from the operating parts of the driving devices, respectively. The operated parts each has a moving guide part extending in a direction of a guide axis orthogonal to a linear driving axis along which the corresponding operating part of the driving device is moved. The operating parts are guided in the respective corresponding moving guide parts to cause a relative rotation of one of the movable base member and the fixed base member against the other. At least one of the linear driving axes extends in a first direction and the other linear driving axes(is) extend in a second direction orthogonal to the first direction. The respective linear driving axes extend in tangential directions of a circle having an arbitrary point on the movable base member or the fixed base member as a center point. The respective guide axes extend in radial directions with respect to the center point.

These and other objects, features and advantages of the present invention will become more apparent upon reading of the following detailed description along with the accompanying drawings.

### BRIEF DESCRIPTION OF THE DRAWINGS

FIG. 1 is a conceptual diagram of an embodiment of the present invention showing a driving mechanism in association with movement of a movable base member relative to a fixed base member.

FIGS. 2A and 2B are conceptual diagrams of the embodiment showing respective states that the movable base member is moved in x-axis direction (rightward and leftward directions) relative to the fixed base member.

FIGS. 3A and 3B are conceptual diagrams of the embodiment showing respective states that the movable base member is moved in y-axis direction (upward and downward directions) relative to the fixed base member.

FIGS. 4A and 4B are conceptual diagrams of the embodiment showing respective states that the movable base member is moved in θ-direction (clockwise and counterclockwise directions) relative to the fixed base member.

FIGS. 5A and 5B are illustrations each explaining a manner as to how linear driving axes are defined.

FIG. 6 is a rear view of a driving mechanism (driving system) embodying the present invention.

FIG. 7 is a front view of the driving mechanism.

FIG. 8 is an exploded perspective view of the driving mechanism.

FIG. 9 is a cross-sectional view taken along the line IX-IX in FIG. 7.

FIG. 10 is a cross-sectional view taken along the line X-X in FIG. 9.

FIG. 11 is a cross-sectional view showing an altered arrangement of an operating part.

FIG. 12 is a functional block diagram for explaining a function of a drive controller.

FIG. 13 is an illustration showing a state that a movable base member is moved in x-axis direction (rightward direction) relative to a fixed base member in the driving mechanism.

FIG. 14 is an illustration showing a state that the movable base member is moved in y-axis direction (upward direction) relative to the fixed base member in the driving mechanism.

FIG. 15 is an illustration showing a state that the movable base member is moved in θ-direction (counterclockwise direction) relative to the fixed base member in the driving mechanism.

FIG. 16 is an illustration showing an altered arrangement in which the movable base member is rotated in θ-direction (counterclockwise direction) relative to the fixed base member in the driving mechanism.

FIG. 17 is a table showing relationships between moving directions of the movable base member, and driving directions of operating parts of first, second, and third driving devices in the driving mechanism.

FIGS. 18A and 18B are illustrations each showing an external appearance of a digital camera incorporated with an anti-shake unit as an embodiment of the present invention, wherein FIG. 18A is a front view of the digital camera, and FIG. 18B is a rear view of the digital camera.

FIG. 19 is a perspective front view of the digital camera.

FIG. 20 is a perspective rear view of the digital camera.

FIG. 21 is a perspective side view of the digital camera.

FIG. 22 is a plan view showing an arrangement of the anti-shake unit to be loaded in the digital camera.

FIG. 23 is a plan view of a fixed base member in the anti-shake unit.

FIG. 24 is a plan view showing a state that the first, the second, and the third driving devices are mounted on the fixed base member in the anti-shake unit.

FIG. 25 is a plan view of a movable base member unit in an assembled state, as well as respective parts constituting the movable base member unit before being assembled.

FIG. 26 is a cross-sectional view taken along the line XXVI-XXVI FIG. 25.

FIG. 27 is a cross-sectional side view of the movable base member unit.

FIG. 28 is a perspective rear view of the digital camera showing a state that an image sensor is about to be moved by the anti-shake unit for shake correction.

FIG. 29 is a block diagram showing an electrical configuration of the digital camera.

FIG. 30 is a block diagram schematically showing an electrical configuration of an anti-shake mechanism including a functional block diagram of an anti-shake section.

FIG. 31 is a block diagram showing a process flow of an anti-shake operation to be implemented by the anti-shake section.

### DETAILED DESCRIPTION OF TITHE PREFERRED EMBODIMENTS

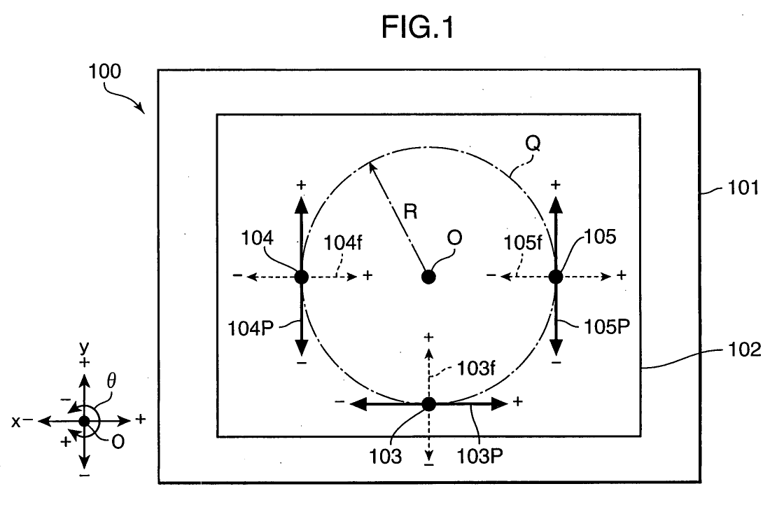

A preferred embodiment of the present invention will be conceptually described with reference to FIGS. 1 to 5B.

A driving mechanism embodying the invention includes a fixed base member, a movable base member movable relative to the fixed base member, and at least three driving devices. Each driving device has an operating part which is moved linearly. The three driving devices are loaded on either one of the fixed base member and the movable base member, at least three operated parts being formed on the other one of the fixed base member and the movable base member where the driving devices are not loaded to receive driving forces from the operating parts of the driving devices, respectively.

The operated parts each has a moving guide part extending in a direction of a guide axis orthogonal to a linear driving axis along which the corresponding operating part of the driving device is moved. The operating parts are guided in the respective corresponding moving guide parts to cause relative rotation of one of the movable base member and the fixed base member against the other. At least one of the linear driving axes extends in a first direction, and the other linear driving axes extend in second directions orthogonal to the first direction. The respective linear driving axes extend in tangential directions of a circle having an arbitrary point on the movable base member or the fixed base member as a center point, the respective guide axes extending radially with respect to the center point.

In the driving mechanism having this arrangement, the movable base member can be rotated in a certain direction, namely, θ-direction relative to the fixed base member, as well as being moved in x-axis direction and y-axis direction relative to the fixed base member, which are parallel movements relative to the fixed base member, by the two-piece unit comprised of the movable base member and the fixed base member. This arrangement enables to provide a compact and lightweight driving mechanism, as compared with the conventional driving mechanism of the same type.

Each of the operating parts may have a pin-shaped member, and the moving guide part of each of the operated parts may have a linear slot along which the pin-shaped member is slidably received. Accordingly, the driving forces are transmitted by engagement of the pin-shaped members in the linear slots. Further, since the pin-shaped members are slidably movable in the linear slots, the pin-shaped members as the operating parts are freely movable in the linear slots, while allowing relative rotation of one of the movable base member and the fixed base member against the other. This arrangement enables to provide the operating parts and the operated parts which attain the object of the invention with a simplified construction comprising the pin-shaped members and the linear slots.

Each of the operating parts may have an engaging projection, and the moving guide part of each of the operated parts may have a linear guide groove engageable with the engaging projection. Accordingly, the driving forces are transmitted by engagement of the engaging projections in the linear guide grooves. Further, since the engaging projections are engageably guided in the linear guide grooves, the engaging projections as the operating parts are freely movable in the linear guide grooves, while allowing relative rotation of one of the movable base member and the fixed base member against the other. This arrangement enables to provide the operating parts and the operated parts which attain the object of the invention with a simplified construction comprising the engaging projections and the linear guide grooves.

One of the three driving devices may have the linear driving axis extending in the first direction, and the other two driving devices each may have the linear driving axis extending in the second direction orthogonal to the first direction. The other two driving devices having the linear driving axes extending in the second direction may be arranged parallel to each other with respect to the center point. The movable base member can be positioned relative to the fixed base member by the operating parts of the three driving devices, the movable base member can be efficiently moved without excessive constraint.

According to the driving mechanism as described above, the movable base member can be rotated in a certain direction, namely, θ-direction, as well as being moved in x-axis direction and y-axis direction which are parallel movements to a flat plane of the movable base member by driving at least the three driving devices.

Referring to FIGS. 1 to 4, the operation of the aforementioned driving mechanism is described. FIG. 1 conceptually shows a driving mechanism 100 embodying the aforementioned arrangements. The driving mechanism 100 includes a pair of base members, namely, a fixed base member 101 and a movable base member 102, wherein the movable base member 102 is movable relative to the fixed base member 101. At least three driving devices (not shown) are loaded on either one of the fixed base member 101 and the movable base member 102. The driving devices each has an operating part that moves linearly. Throughout the specification and the claims, the axis of direction along which the operating part is moved is called as “linear driving axis”. At least three operated parts on which driving forces from the operating parts of the driving devices are acted respectively are formed in the other one of the fixed base member and the movable base member where the driving devices are not loaded. In other words, in the case where the driving devices are loaded on the fixed base member 101, the operated parts are formed in the movable base member 102. Conversely, in the case where the driving devices are loaded on the movable base member 102, the operated parts are formed in the fixed base member 101. In FIG. 1, since three driving devices are shown, three operated parts 103, 104, and 105 are defined accordingly. The operating parts of the driving devices apply such driving forces to the respective corresponding operated parts 103, 104, and 105 as to move the operated parts 103, 104, and 105 in + direction or − direction along linear driving axes 103p, 104p, and 105p, respectively.

The linear driving axis 103p extends in x-axis direction (first direction), and the other two linear driving axes 104p and 105p each extend in y-axis direction (second direction) orthogonal to the x-axis direction, as recited in the arrangement. The linear driving axes 104p and 105p extending in the y-axis direction are parallel to each other with respect to a center point O, which will be described later. Further, guide axes 103f, 104f, and 105f are defined in the operated parts 103, 104, and 105 in such a manner that the guide axes 103f, 104f, and 105f extend in directions orthogonal to the linear driving axes 103p, 104p, and 105p for guiding the corresponding operating parts, respectively. The operated parts 103, 104, and 105 have moving guide parts (not shown) extending in the longitudinal directions of the guide axes 103f, 104f, and 105f, respectively. The operating parts are movable in the moving guide parts along the guide axes 103f, 104f, and 105f in + direction or − direction to cause relative rotation of the movable base member 102 to the fixed base member 101.

Further, the linear driving axes 103p, 104p, and 105p extend in the tangential directions of the circle Q having the arbitrary point on the flat plane of the movable base member 102 or the fixed base member 101, as the center point O, respectively. In other words, the three driving devices generate the driving forces acted in the tangential directions of the circle Q to move the movable base member 102 relative to the fixed base member 101. The guide axes 103f, 104f, and 105f extend in racial directions with respect to the center point O.

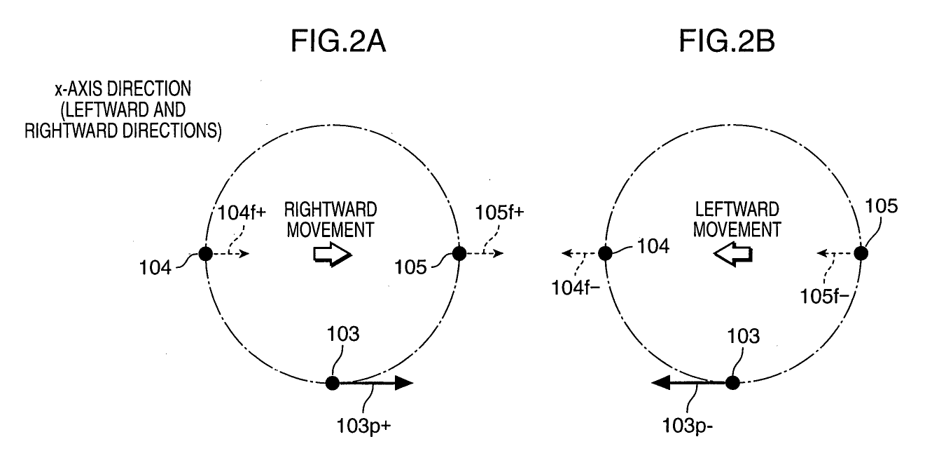

In the driving mechanism 100 having the above arrangement, the movable base member 102 can be moved in the x-axis direction or the y-axis direction by driving the operating part extending in the x-axis direction or the operating part extending in the y-axis direction, and applying the driving force to the corresponding operated part in the linear driving axis 103p or the linear driving axis 104p, while allowing the other operating parts to freely move along the guide axis 103f, or the guide axes 104f and 105f. In addition to this, since the linear driving axes 103p, 104p, and 105p extend in the tangential directions of the circle Q, the movable base member 102 can be rotated relative to the fixed base member 101 by applying such driving forces to the operating parts as to rotate the movable base member 102 about the axis of rotation in a certain rotating direction. This feature is described in detail referring to FIGS. 2A through 4B.

FIGS. 2A and 2B are illustrations showing respective states as to how the movable base member 102 is moved in x-axis directions, specifically, leftward and rightward directions. As shown in FIG. 2A, in the case where the movable base member 102 is moved rightward, a driving force is applied to the operated part 103 by the corresponding operating part to move the operated part 103 in + direction shown by the arrow 103p+, which is a rightward direction along the linear driving axis 103p, whereas the operating parts corresponding to the operated parts 104 and 105 are kept unmoved. In other words, the operating parts at the corresponding operated parts 104 and 105 are freely movable in + directions shown by the arrows 104f+ and 105f+ along the guide axes 104f and 105f, respectively. As a result, the movable base member 102 is moved rightward by the driving force acted in + direction along the linear driving axis 103p, and by guiding the other operating parts in the operated parts 104 and 105 in + direction along the guide axes 104f and 105f.

On the other hand, as shown in FIG. 2B, in the case where the movable base member 102 is moved leftward, a driving force is applied to the operated part 103 by the corresponding operating part to move the operated part 103 in − direction shown by the arrow 103p−, which is a leftward direction along the linear driving axis 103p, whereas the operating parts corresponding to the operated parts 104 and 105 are kept unmoved. Thereby, the operating parts corresponding to the operated parts 104 and 105 are freely movable in − direction shown by the arrows 104f− and 105f− along the guide axes 104f and 105f, respectively. As a result, the movable base member 102 is moved leftward by the driving force acted in − direction along the linear driving axis 103p, and by guiding the other operating parts in the operated parts 104 and 105 in − direction along the guide axes 104f and 105f.

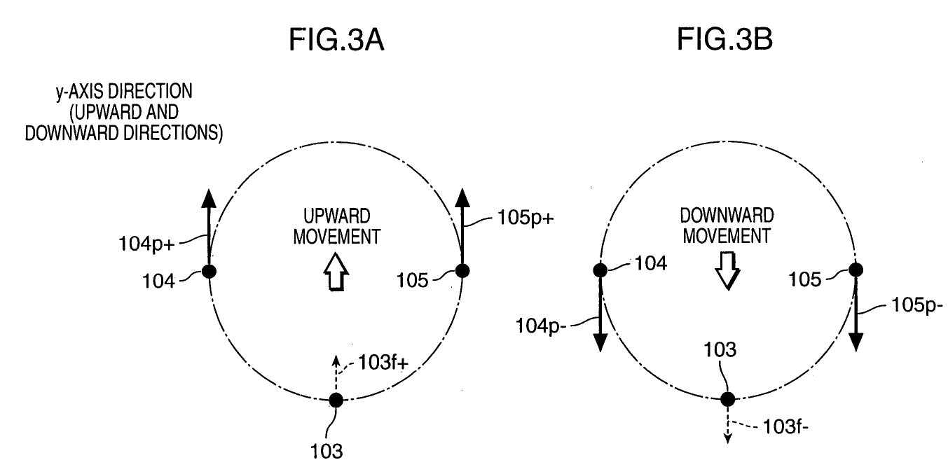

FIGS. 3A and 3B are illustrations showing respective states as to how the movable base member 102 is moved in y-axis directions, specifically, upward and downward directions. As shown in FIG. 3A, in the case where the movable base member 102 is moved upward, driving forces are applied to the operated parts 104 and 105 by the corresponding operating parts to move the operated parts 104 and 105 in + direction shown by the arrows 104p+ and 105p+, which are upward directions along the linear driving axes 104p and 105p, whereas the operating part corresponding to the operated part 103 is kept unmoved. Thereby, the operating part corresponding to the operated part 103 is freely movable in + direction shown by the arrow 103f+ along the guide axis 103f. As a result, the movable base member 102 is moved upward by the driving forces acted in + direction along the linear driving axes 104p and 105p, and by guiding the operating part corresponding to the operated part 103 in + direction along the guide axis 103f.

On the other hand, as shown in FIG. 3B, in the case where the movable base member 102 is moved downward, driving forces are applied to the operated parts 104 and 105 by the corresponding operating parts to move the operated parts 104 and 105 in − direction shown by the arrows 104p− and 105p− along the linear driving axes 104p and 105p, respectively, whereas the operating part corresponding to the operated part 103 is kept unmoved. Thereby, the operating part corresponding to the operated part 103 is freely movable in − direction shown by the arrow 103f− along the guide axis 103f. As a result, the movable base member 102 is moved downward by the driving forces acted in − direction along the linear driving axes 104p and 105p, and by guiding the operating part corresponding to the operated part 103 in − direction along the guide axis 103f.

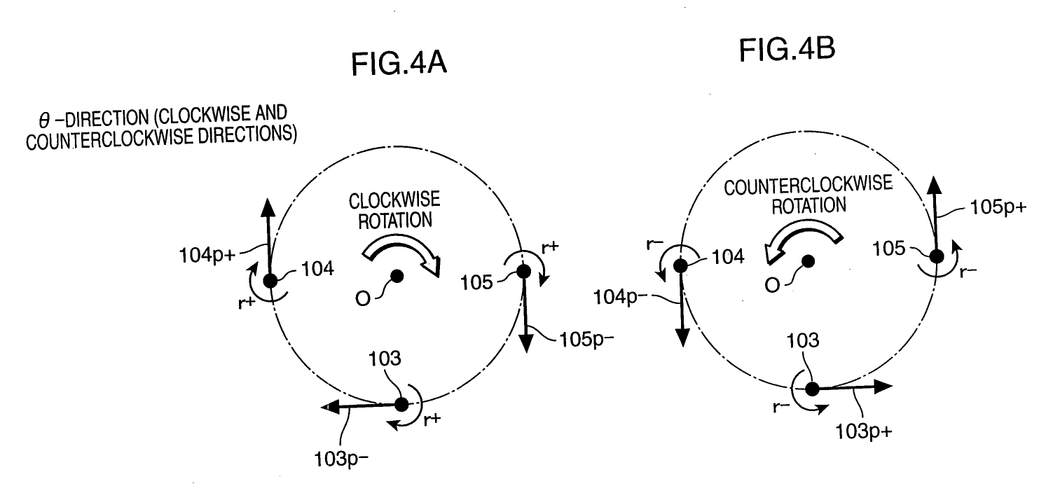

Next, FIGS. 4A and 4B are illustrations showing respective states as to how the movable base member 102 is rotated in − direction (clockwise and counterclockwise directions) relative to the fixed base member 101. As shown in FIG. 4A, in the case where the movable base member 102 is rotated clockwise, a driving force is applied to the operated part 104 by the corresponding operating part to move the operated part 104 in + direction shown by the arrows 104p+ along the linear driving axis 104p. Further, driving forces are applied to the operated parts 103 and 105 by the corresponding operating parts to move the operated parts 103 and 105 in − directions shown by the arrows 103p− and 105p− along the linear driving axes 103p and 105p, respectively. As a result, the movable base member 102 is rotated clockwise by the driving forces acted in clockwise direction along the linear driving axes 103p, 104p, and 105p. At this time, relative rotation is generated between the moving guide parts and the operating parts at the operated parts 103, 104, and 105, respectively, to allow relative rotation of the movable base member 102 to the fixed base member 101. Thereby, rotating forces to rotate the movable base member 102 about the center point O in + directions shown by the arrows r+, which are clockwise directions, are generated at the operated parts 103, 104, and 105, respectively.

On the other hand, as shown in FIG. 4B, in the case where the movable base member 102 is rotated counterclockwise, a driving force is applied to the operated part 104 by the corresponding operating part to move the operated part 104 in − direction shown by the arrow 104p− along the linear driving axis 104p. Further, driving forces are applied to the operated parts 103 and 105 by the corresponding operating parts to move the operated parts 103 and 105 in + directions shown by the arrows 103p+ and 105p+ along the linear driving axes 103p and 105p, respectively. As a result, the movable base member 102 is rotated counterclockwise by the driving forces acted in counterclockwise direction along the linear driving axes 103p, 104p, and 105p. At this time, relative rotation is generated between the moving guide parts and the operating parts at the operated parts 103, 104, and 105, respectively, to allow relative rotation of the movable base member 102 to the fixed base member 101. Thereby, rotating forces to rotate the movable base member 102 about the center point O in − directions shown by the arrows r−, which are counterclockwise directions, are generated at the operated parts 103, 104, and 105, respectively.

In the above arrangement, various linear actuators capable of linearly moving the relevant operating parts can be used as the driving device. Examples of a power source of the driving device include a pulse motor, a piezoelectric actuator, a linear motor, and a moving coil. As shown in FIGS. 3A and 3B, in the case where the movable base member 102 is moved in the y-axis direction, it may be possible to drive either one of the driving devices having the linear driving axes 104p and 105p to generate a driving force acted in the linear diving axis 104p or 105p, and to allow the other one of the driving devices to be driven, as far as such an arrangement is realizable depending on the type of the actuator.

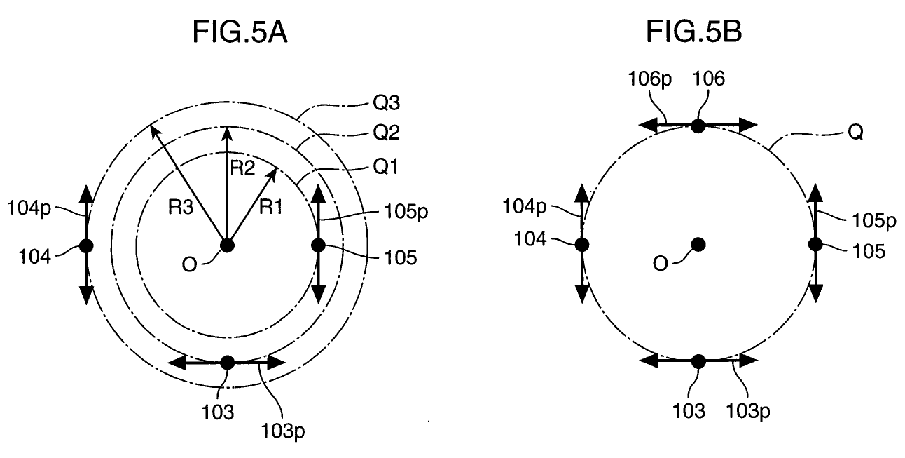

In the driving mechanism 100 shown in FIG. 1, all the linear driving axes 103p, 104p, and 105p extend in the tangential directions of the circle Q having the center point O. Alternatively, as shown in FIG. 5A, the linear driving axes 103p, 104p, and 105p may extend in tangential directions of circles Q1, Q2, and Q3 which have a common center point O but have radii R₁, R₂, and R₃ different from each other, respectively. As a further altered form, arbitrary two of the linear driving axes may extend in tangential directions of a circle, and the remaining one of the linear driving axes may extend in a tangential direction of another circle having a center point identical to that of the former circle but a radius different from that of the former circle. In the case where the linear driving axes 103p, 104p, and 105p extend in the tangential directions of circles Q₁, Q₂, and Q₃ having the same center point P but different radii from each other, moving amounts of the operating parts in the linear driving axes are different from each other in rotating the movable base member 102 relative to the fixed base member 101, as shown in FIGS. 4A and 4B. Accordingly, it is necessary to adjust the movement amounts based on the arranged positions of the linear diving axes.

In the driving mechanism 100 shown in FIG. 1, the three operated parts 103, 104, and 105 are defined. Alternatively, as shown in FIG. 5B, four driving devices may be used, and four operated parts 103, 104, 105, and 106 may be defined accordingly. Namely, FIG. 5B shows the altered arrangement that a linear driving axis 106p extending in x-axis direction is provided in addition to the arrangement shown in FIG. 1. A plane can be defined and positioned by setting three support points. In view of this, at least three operated parts are provided in the embodiment of the invention to position the movable base member relative to the fixed base member. However, in the case where a heavy member is to be loaded on the movable base member, a driving force acted in a single axis direction by a single driving device may be weak. In such a case, it is desirable to adopt the arrangement having the four support points as shown in FIG. 5B. If, however, an arrangement having support points more than three is adopted, excessive constraint may be exerted on the movable base member since arbitrary three points among the support points is enough to position the movable base member relative to the fixed base member. In view of this, it is desirable to adopt the arrangement of providing the three operated parts as shown in FIG. 1 except for the case that an extremely large driving force is required.

Further, the two driving devices having the linear driving axes extending in the second direction may be arranged in a direction parallel to a direction of gravitational force if the fixed base member and the movable base member are arranged at an upright position. Specifically, in the case where the fixed base member 101 and the movable base member 102 are arranged at an upright position, and the y-axis direction extends in the direction of gravitational force in FIG. 1, it is desirable to extend the two linear driving axes parallel to each other in y-axis direction. FIG. 1 satisfies this requirement. Since the movable base member is required to be lifted up in y-axis direction against the gravitational force, a relatively large driving force may be required. The above arrangement enables to generate such a relatively large driving force by driving the two driving devices.

Since the driving forces are applied by the two driving devices in a direction substantially equal to the direction of the gravitational force, a sufficient driving force against the gravitational force can be applied, and the movable base member can be smoothly moved relative to the fixed base member in the case where the fixed base member and the movable base member are arranged at the upright position.

There may be provided a driving system which comprises the aforementioned driving mechanism, a driven member mounted on the movable base member, and a drive controller which controllably moves the operating parts of the driving devices.

In this driving system, the operating parts of the driving devices are driven in a desired direction (+ direction or − direction) by the drive controller. Thereby, the driven member loaded on the movable base member is moved in one of the two axis directions or rotated in a certain direction.

The movable base member can be rotated in a certain direction, namely, θ-direction relative to the fixed base member, as well as being moved in the x-axis direction and the y-axis direction relative to the fixed base member, which are parallel movements, by the two-piece unit comprised of the movable base member and the fixed base member. This arrangement enables to provide a compact and lightweight driving mechanism, as compared with the conventional driving mechanism of the same type.

The drive controller may be operative to execute a first drive mode of moving the movable base member in the first direction by driving the driving device having the linear driving axis extending in the first direction, a second drive mode of moving the movable base member in the second direction by driving the driving device having the linear driving axis extending in the second direction, and a third drive mode of rotating the movable base member about an axis of rotation thereof by driving the driving device having the linear driving axis extending in the first direction, and the driving device having the linear driving axis extending in the second direction. The movable base member can be moved in the x-axis direction, the y-axis direction, and rotated in the 0-direction by the three drive modes of the drive controller.

There may be provided an anti-shake unit comprising an image sensor which converts an object light image into an electrical signal, and the aforementioned driving mechanism. The image sensor is mounted on the movable base member as a driven member. In this anti-shake unit, the operating parts of the driving devices are driven in a desired direction (+ direction or − direction) by drive controller. Thereby, the driven member loaded on the movable base member is moved in one of the two axis directions or rotated in a certain direction. The movable base member loaded with the image sensor can be rotated in a certain direction, namely, θ-direction relative to the fixed base member, as well as being moved in the x-axis direction and the y-axis direction, which are parallel movements relative to the fixed base member, by the two-piece unit comprised of the movable base member and the fixed base member. This arrangement enables to provide a compact and lightweight anti-shake unit, as compared with the conventional anti-shake unit.

There may be provided an image sensing apparatus incorporated with the anti-shake unit, a shake detector for detecting angular velocities of a main body of the image sensing apparatus in a pitch direction, in a yaw direction, and in a rolling direction based on a shake applied to the apparatus main body, a corrective amount calculator for calculating corrective amounts by which the apparatus main body is to be correctively moved in the pitch direction, in the yaw direction, and in the rolling direction to cancel the shake of the apparatus main body, based on detection results of the shake detector, and a drive controller for controlling the driving devices to correctively move the operating parts thereof in the pitch direction, in the yaw direction, and in the rolling direction, depending on the corrective amounts calculated by the corrective amount calculator. This image sensing apparatus is compact, and can perform anti-shake operation of moving the image sensor in the rolling direction, as well as in the pitch direction and in the yaw direction.

In the image sensing apparatus, the first direction and the second direction of the linear driving axes correspond to the pitch direction and the yaw direction, respectively, or the yaw direction and the pitch direction, respectively. The drive controller is operative to execute a pitch drive mode of correctively moving the movable base member in the pitch direction by driving only the driving device having the linear driving axis extending in the direction along the pitch direction based on the corrective amount in the pitch direction, or a yaw drive mode of correctively moving the movable base member in the yaw direction by driving only the driving device having the linear driving axis extending in the direction along the yaw direction based on the corrective amount in the yaw direction, and execute a rolling drive mode of rotating the movable base member about an axis of rotation thereof by driving the driving device having the linear driving axis extending in the first direction, and the driving device having the linear driving axes extending in the second direction.

In this construction, the operating parts of the driving devices are driven based on the detection results in the pitch direction, the yaw direction, and the rolling direction. This enables to provide an image sensing apparatus capable of swinging the image sensor for anti-shake operation in such a direction as to cancel the shake applied to the image sensing apparatus in the pitch direction, the yaw direction, and the rolling direction.

Accordingly, anti-shake operation of moving the image sensor loaded on the movable base member in the pitch direction, the yaw direction, and the rolling direction can be securely performed by the three drive modes of the drive controller.

Next, preferred embodiments of the present invention will be described in more details.

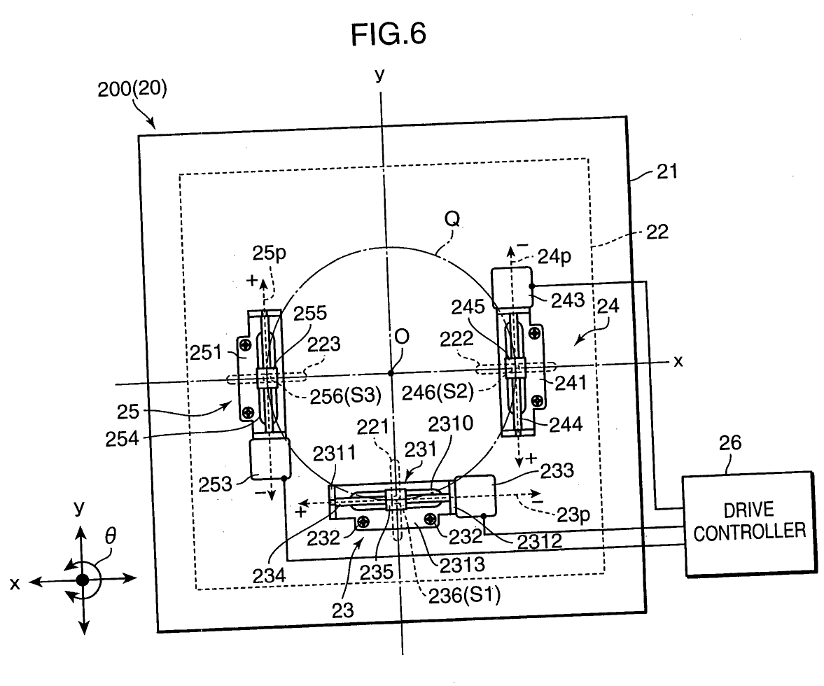

Referring to FIGS. 6 through 10 showing a driving system including a driving mechanism 200 (anti-shake unit 20), the driving mechanism 200 includes a fixed base member 21 in the shape of a plate, a movable base member 22 in the shape of a plate, and first, second, and third driving devices 23, 24, 25 to be loaded on the fixed base member 21. In the embodiment, an image sensor, which is a driven member Wt, is fixedly mounted on the movable base member 22. In this sense, the driving mechanism 200 shown in FIGS. 6 through 10 is an embodiment of the anti-shake unit 20, which is an anti-shake mechanism of swinging an image sensor incorporated in a digital still camera or the like.

The fixed base member 21 and the movable base member 22 each is a planar member made of a metal, a rigid resin, or a like material. The fixed base member 21 and the movable base member 22 are placed one over the other with respective flat portions thereof opposing to each other. The movable base member 22 is movable relative to the fixed base member 21. Specifically, the fixed base member 21 is fixedly attached to a frame of an apparatus in which the driving mechanism 200 is incorporated, and the movable base member 22 is movable relative to the fixed base member 21 by driving forces generated by the first, the second, and the third driving devices 23, 24, 25.

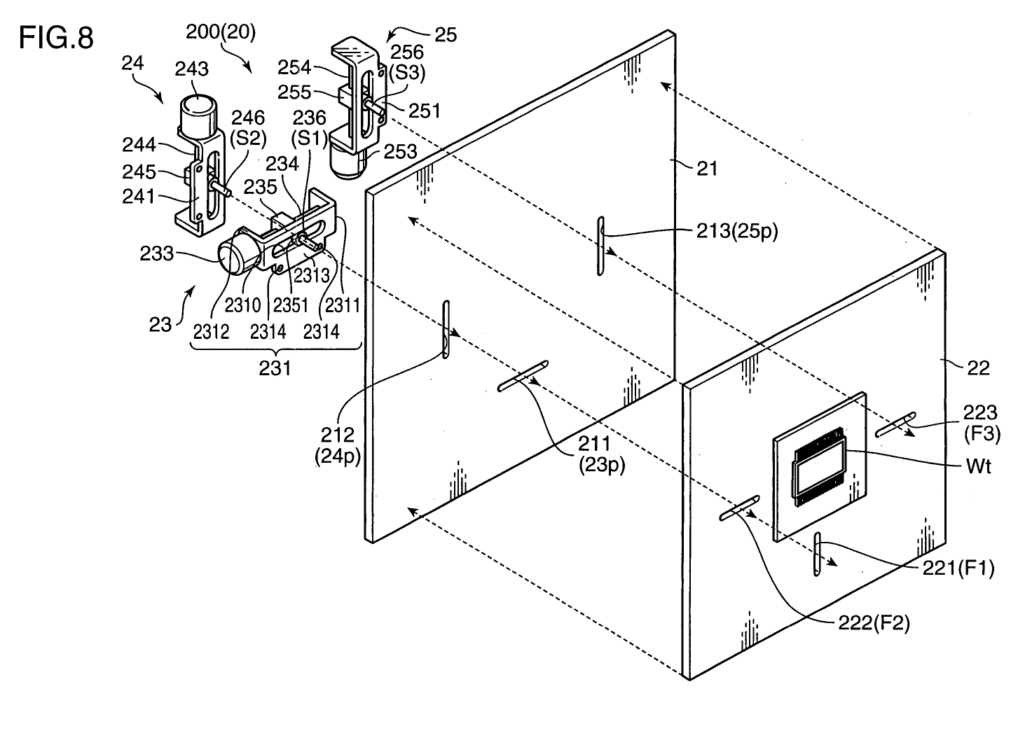

As shown in FIG. 8, three linear slots (first, second, and third slots 211, 212, 213) are formed in the fixed base member 21. The first, second, and third linear slots 211, 212, 213 extend in respective movable directions of operating parts of the first, the second, and the third driving devices 23, 24, 25, namely, along directions of linear driving axes 23p, 24p, 25p, which will be described later. Likewise, three linear slots (first, second, and third slots 221, 222, 223) are formed in the movable base member 22. The first, second, and third linear slots 221, 222, 223 extend in directions of guide axes F1, F2, F3 perpendicular to the extending directions of the first, the second, and the third slots 211, 212, 213, respectively. The first, the second, and the third slots 221, 222, 223 function as moving guide parts for causing relative rotation of the operating parts of the first, the second, and the third driving devices 23, 24, 25, respectively.

A linear actuator with a pulse motor (stepping motor) as a driving source is used in each of the first, the second, and the third driving devices 23, 24, 25. Since the arrangements of the first, the second, and the third driving devices 23, 24, 25 are identical to each other, the construction of the first driving device 23 is described in detail, as a representative of the devices 23, 24, and 25. The first driving device 23 has a frame member 231, a pulse motor 233, a driving shaft 234, a movable slider 235, and a pin 236 (pin-shaped member) serving as an operating part S1.

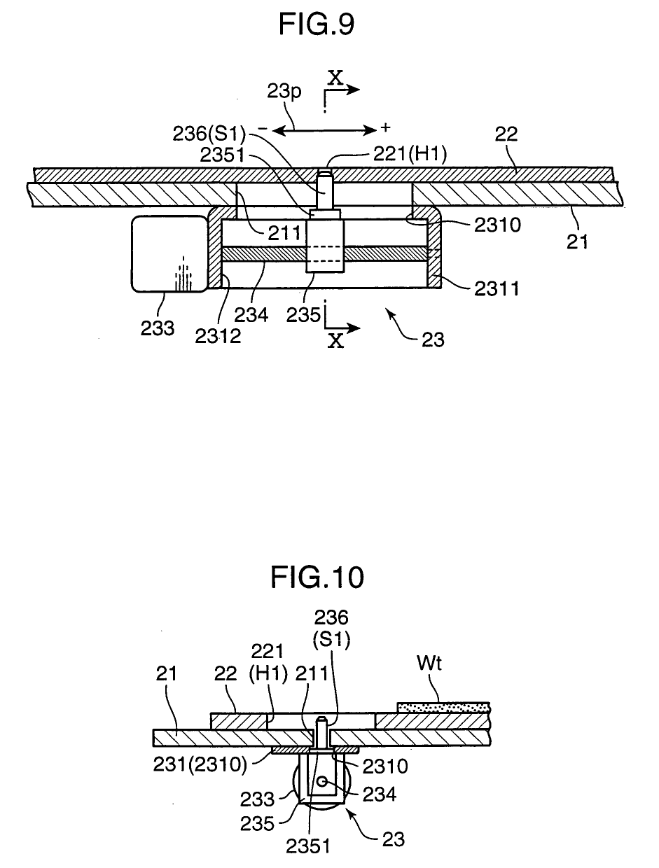

The frame member 231 is formed by bending a metal plate into a certain shape, and is functioned as a support member for the pulse motor 233 and the driving shaft 234, as well as an attachment for fixedly mounting the first driving device 23 on the fixed base member 21. The frame member 231 includes an oblong hole 2310, a pair of bent portions 2311, 2312, a flange portion 2313, and two screw holes 2314, 2314. As shown in FIG. 9, the oblong hole 2310 has such a length as to match with the first slot 211 of the fixed base member 21, and a width substantially identical to the diameter of a guide portion 2351 of the movable slider 235, which will be described later (see FIG. 10).

The bent portions 2311, 2312 serve as a bearing for the driving shaft 234 and a support portion for the pulse motor 233. Specifically, a bearing hole for supportively receiving a lead end of the driving shaft 234 is formed in the first bent portion 2311, a rod hole for passing through a base end of the driving shaft 234 is formed in the second bent portion 2312, and the pulse motor 233 is fastened to the second bent portion 2312 by a screw or a like member. The flange portion 2313 is formed to hold the frame member 231 on the fixed base member 21. The two screw holes 2314, 2314 are formed in the flange portion 2313. As shown in FIG. 6, the frame member 231 is fixed to the fixed base member 21 by fastening a screw 232 into each of the screw holes 2314, 2314.

The pulse motor 233 includes a rotor and a stator. An example of the pulse motor 233 is of a micro step drive type which is driven by inputting a predetermined drive pulse. With use of the pulse motor 233, minute drive control is executable, and the driving state of the first driving device 23 can be grasped by counting the inputted drive pulse. With this arrangement, driving under a so-called open loop control is executable, wherein feedback control or a like control is not necessary, and the control arrangement is simple.

The driving shaft 234 is a shaft member directly connected to the rotor of the pulse motor 233 for generating a rotational driving force, and a spiral screw is formed in the outer circumference of the driving shaft 234. The movable slider 235 is thread-connected to the driving shaft 234. The movable slider 235 slides forward along the driving shaft 234 toward the lead end portion thereof (hereinafter, this movement is called as “+ driving”), or slides backward along the driving shaft 234 toward the base end portion thereof (hereinafter, this movement is called as “− driving”) when the driving shaft 234 is rotated forward or reverse by the pulse motor 233.

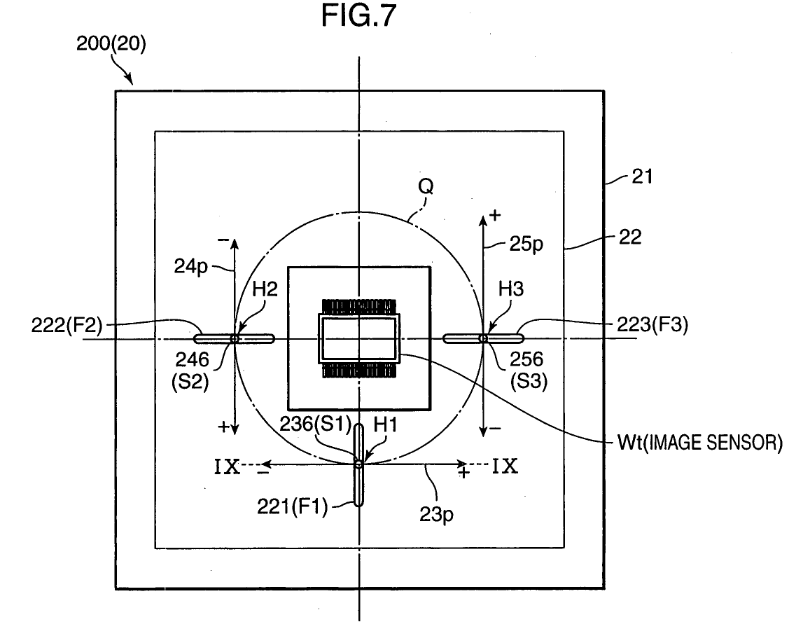

The pin 236 functions as the operating part S1 for applying a driving force to the movable base member 22. The pin 236 is integrally assembled with the movable slider 235, and is linearly moved along with forward/backward movement of the movable slider 235 along the driving shaft 234. An axis of direction along which the pin 236 is moved is defined as the linear driving axis 23p in the first driving device 23. In other words, the arranged position and the extending direction of the driving shaft 234 define the setting position of the linear driving axis 23p. The symbols “+” “−” near the arrows of the linear driving axis 23p in FIGS. 6 and 7 represent the driving directions of the pin 236 (operating part S1) along the linear driving axis 23p in response to + driving and − driving of the movable slider 235, respectively.

The disk-like guide portion 2351 having a certain diameter is arranged between the movable slider 235 and the pin 236. As described above, the diameter of the guide portion 2351 is substantially equal to the width of the oblong hole 2310, and the guide portion 2351 is fitted in the oblong hole 2310. By the engagement of the guide portion 2351 in the oblong hole 2310, rotation of the movable slider 235 around the axis of the driving shaft 234 is restrained, whereby the movable slider 235 (pin 236) linearly reciprocates in the longitudinal direction of the oblong hole 2310, namely, in the extending direction of the first slot 211.

Similarly to the first driving device 23, the second driving device 24 includes a frame member 241, a pulse motor 243, a driving shaft 244, a movable slider 245, and a pin 246 serving as an operating part S2. Similarly to the linear driving axis 23p, the arranged position and the extending direction of the driving shaft 244 define the setting position of the linear driving axis 24p, so that the pin 246 (operating part S2) makes + driving or − driving along the linear driving axis 24p. Likewise, the third driving device 25 includes a frame member 251, a pulse motor 253, a driving shaft 254, a movable slider 255, and a pin 256 serving as an operating part S3. Similarly to the linear driving axes 23p, 24p, the arranged position and the extending direction of the driving shaft 254 define the setting position of the linear driving axis 25p, so that the pin 256 (operating part S3) makes + driving or − driving along the linear driving axis 25p.

Next, the arrangement relation of the linear driving axes 23p, 24p, and 25p (first, second, and third driving devices 23, 24, and 25) is described. As shown in FIG. 6, the linear driving axis 23p of the first driving device 23 extends in the x-axis direction (first direction) of the fixed base member 21, and the linear driving axes 24p and 25p of the second and third driving devices 24 and 25 each extends in the y-axis direction (second direction) orthogonal to the x-axis direction.

Further, the linear driving axes 23p, 24p, 25p each extends in a direction coincident with a tangential direction of a circle Q having a center point O (center of optical axis of the image sensor 30, namely, the driven member Wt) defined on the fixed base member 21. Since the linear driving axes 24p and 25p extending in the y-axis direction are arrayed parallel to each other with respect to the center point O, the first, the second, and the third driving devices 23, 24, and 25 are fixed on the fixed base member 21 in such a manner that the linear driving axes 23p and 24p (23p and 25p) are spaced apart from each other by 90° with respect to the center point O.

Next, the structure as to how the fixed base member 21, the movable base member 22, and the first, the second, and the third driving devices 23, 24, and 25 are assembled to each other is described. As described above, the fixed base member 21 and the movable base member 22 are placed one over the other in a state that the respective flat portions thereof oppose to each other. The fixed base member 21 and the movable base member 22 are placed one over the other in such a manner that the first, the second, and the third slots 211, 212, and 213 of the fixed base member 21 are orthogonal to the first, the second, and the third slots 221, 222, and 223 of the movable base member 22 to make cross shapes in front view, respectively. The lead ends of the pins 236, 246, and 256 of the first, the second, and the third driving devices 23, 24, and 25 are fitted in the first slot 221 of the movable base member 22 through the first slot 211 of the fixed base member 21, in the second slot 222 through the second slot 212, and in the third slot 223 through the third slot 213 (see FIGS. 9 and 10), respectively.

Although not illustrated, there is provided urging means such as a spring for urging the fixed base member 21 and the movable base member 22 toward each other. With this arrangement, the movable base member 22 is positioned at a certain position relative to the fixed base member 21 by the three pins 236, 246, 256.

In the above arrangement, when a driving force is applied to the first driving device 23, for instance, to move the pin 236 along the linear driving axis 23p (see FIGS. 7 and 9), the pin 236 is freely movable in the first slot 211 of the fixed base member 21, but the movement thereof is interfered by a side wall of the first slot 221 of the movable base member 22. As a result, the movable base member 22 is moved along the linear driving axis 23p. In other words, the first slot 221 of the movable base member 22 functions as an operated part H1 on which the driving force from the pin 236 serving as the operating part S1 is acted. Similarly, the second slot 222 functions as an operated part H2 on which a driving force from the pin 246 serving as the operating part S2 is acted, and the third slot 223 functions as an operated part H3 on which a driving force from the pin 256 serving as the operating part S3 is acted. Thus, the movable base member 22 has the three operated parts H1, H2, and H3 corresponding to the three operating parts S1, S2, and S3 of the first, the second, and the third driving devices 23, 24, and 25.

The first, the second, and the third slots 221, 222, and 223 of the movable base member 22 also function as moving guide parts (guide axes F1, F2, and F3), respectively, for allowing the pins 236, 246, and 256 as the operating parts S1, S2, and S3 to freely move therein while causing relative rotation of the movable base member 22 to the fixed base member 21. As mentioned above, since the fixed base member 21 and the movable base member 22 are assembled to each other in a state that the first, the second, and the third slots 211, 212, and 213 of the fixed base member 21 extend orthogonal to the first, the second, and the third slots 221, 222, and 223 of the movable base member 22, respectively, as shown in FIG. 7, the guide axes F1, F2, and F3 extend orthogonal to the linear driving axes 23p, 24p, and 25p, respectively. Thus, the guide axes F1, F2, and F3 extend in radial directions with respect to the center point O.

Since the guide axes F1, F2, and F3, and the linear driving axes 23p, 24p, and 25p have the aforementioned positional relation, when a driving force is applied to the first driving device 23 to move the pin 236 along the linear driving axis 23p, the pins 246 and 256 of the second and the third driving devices 24 and 25 are moved relative to the movable base member 22 along the second and the third slots 222 and 223 (guide axes F2 and F3) by keeping the pins 246 and 256 of the second and the third driving devices 24 and 25 unmoved. Similarly, when a driving force is applied to the second and third driving devices 24 and 25 to move the pins 246 and 256 along the linear driving axes 24p and 25p, the pin 236 of the first driving device 23 is moved relative to the movable base member 22 along the first slot 221 (guide axis F1) by keeping the pin 236 of the first driving device 23 unmoved.

Further, in the case where a driving force is applied to the movable base member 22 to rotate the movable base member 22 relative to the fixed base member 21 by the first, the second, and the third driving devices 23, 24, and 25, relative rotation is generated between the pins 236, 246, and 256, and the first, the second, and the third slots 221, 222, and 223 while allowing the pins 236, 246, and 256 to freely move along the guide axes, F1, F2, and F3, respectively. As a result, the movable base member 22 is allowed to be smoothly rotated relative to the fixed base member 21. It is desirable that the pins 236, 246, and 256 each has a cylindrical shape to facilitate rotation around the corresponding axis thereof.

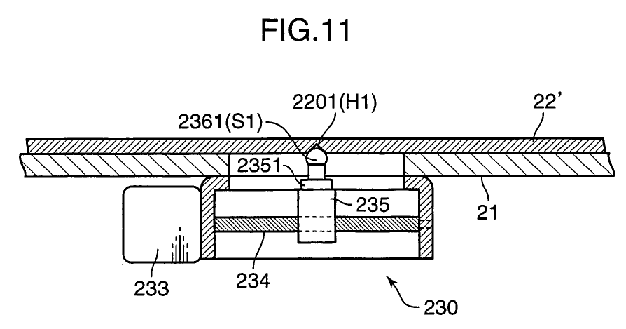

Concerning the engagement of the operating parts S1, S2, and S3 in the operated parts H1, H2, and H3, alternatively, as shown in FIG. 11, an engaging projection 2361 as an operating part S1 may be formed on a movable slider 235, and a linear guide groove 2201 (moving guide part as an operated part H1) engageable with the engaging projection 2361 may be formed in a movable base member 22′, in place of the engagement of the cylindrical pins 236, 246, and 256 in the slots 221, 222, and 223.

The engaging projection 2361 is a projecting member having a spherical part at a distal end thereof, and is integrally attached to the movable slider 235 by way of the guide portion 2351. The linear guide groove 2201 is a groove having a V-shape in cross section, and the engaging projection 2361 is engageably guided in the guide groove 2201 in a state that the spherical part thereof is partly received therein. Since the engaging projection 2361 is a projecting member having a spherical part at a distal end thereof, the engaging projection 2361 is pivotally engaged in the V-shaped guide groove 2201, whereby the movable base member 22′ is rotatable relative to the fixed base member 21. With this arrangement, since the operating part S1 smoothly comes into contact with the operated part H1, and the movable base member 22′ is placed over the fixed base member 21 with no or less clearance, the movable base member 22′ can be positioned precisely relative to the fixed base member 21 with no or less displacement.

In the above arrangement, described is a case where the first, the second, and the third driving devices 23, 24, and 25 are loaded on the fixed base member 21. Alternatively, the first, the second, and the third driving devices 23, 24, and 25 may be loaded on the movable base member 22. In such an altered arrangement, the first, the second, and the third driving devices 23, 24, and 25 are moved with the movable base member 22. In view of this, it is desirable to form the first, the second, and the third slots 221, 222, and 223 as operated parts in the fixed base member 21.

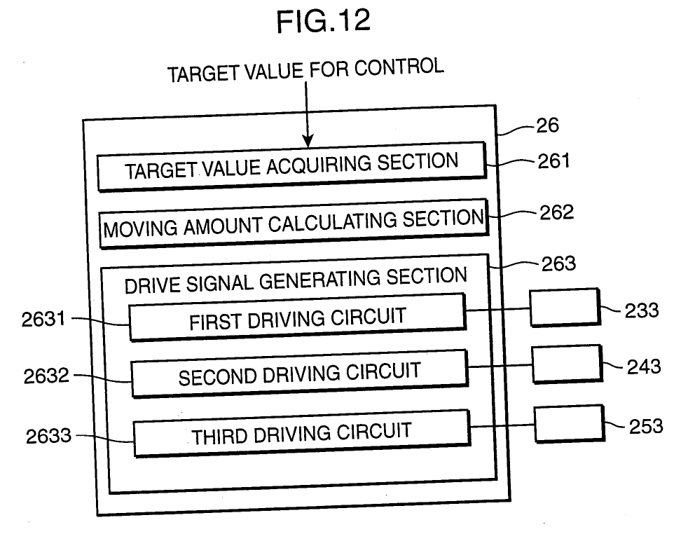

The drive controller 26 is adapted to generate drive signals for driving the pulse motors 233, 243, and 253 depending on a predetermined target value for moving the movable base member 22, and as shown in FIG. 12, the drive controller 26 functionally includes a target value acquiring section 261, a moving amount calculating section 262, and a drive signal generating section 263.

The target value acquiring section 261 is adapted to acquire a sensing result, a computed value, a movement command value, or the like, which represents a target value for driving. Specifically, the target value acquiring section 261 acquires predetermined target values (e.g., servo control target values) for moving the movable base member 22 in x-axis direction, y-axis direction, and θ-direction. The moving amount calculating section 262 converts the acquired target values into moving amounts for moving the operating parts S1, S2, and S3 (pins 236, 246, and 256) of the first, the second, and the third driving devices 23, 24, and 25. The drive signal generating section 263 includes a first driving circuit 2631 for generating a drive signal to drive the pulse motor 233, a second driving circuit 2632 for generating a drive signal to drive the pulse motor 243, and a third driving circuit 2633 for generating a drive signal to drive the pulse motor 253. The respective driving circuits 2631, 2632, and 2633 generate predetermined drive pulses depending on the signals indicative of moving amounts in x-axis direction, y-axis direction, and θ-direction, and execute + driving or − driving of the pulse motors 233, 243 and 253 by the respective predetermined moving amounts.

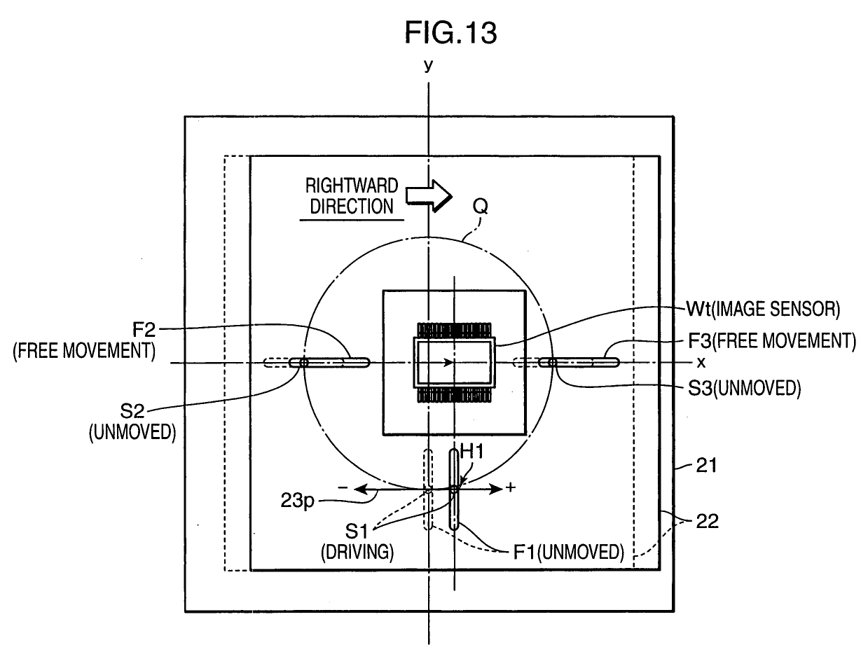

An operation of the driving mechanism 200 having the above construction is described referring to FIGS. 13 through 16. FIG. 13 is an illustration schematically showing a state that the movable base member 22 is moved relative to the fixed base member 21 rightward in x-axis direction. In this case, the operating part S1 (pin 236) of the first driving device 23 makes + driving along the linear driving axis 23p, whereas the operating parts S2 and S3 (pins 246 and 256) of the second and the third driving devices 24 and 25 are kept unmoved. As a result, a driving force to move the operated part H1 rightward in x-axis direction is applied by the operating part S1, and the operating parts S2 and S3 cause free movement of the movable base member 22 relative to the fixed base member 21 along the guide axes F2 and F3 (along the second and third slots 222 and 223). Thereby, the movable base member 22 is moved rightward in x-axis direction, and consequently, the image sensor 30 as the driven member Wt is moved rightward in x-axis direction together with the movable base member 22.

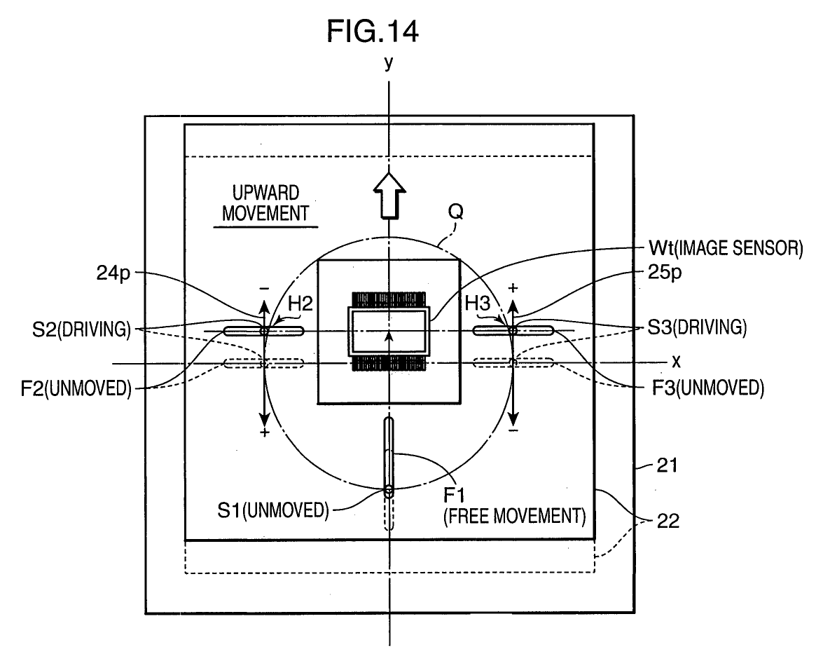

FIG. 14 is an illustration schematically showing a state that the movable base member 22 is moved upward in y-axis direction. In this case, the operating part S2 (pin 246) of the second driving device 24 makes − driving along the linear driving axis 24p, and the operating part S3 (pin 256) of the third driving device 25 makes +driving along the linear driving axis 25p. On the other hand, the operating part S1 (pin 236) of the first driving device 23 is kept unmoved. As a result, driving forces to move the operated parts H2 and H3 upward in y-axis direction are applied to the operated parts H2 and H3 by the operating parts S2 and S3, and the operating part S1 causes free movement of the movable base member 22 relative to the fixed base member 21 along the guide axis F1 (first slot 221). Thereby, the movable base member 22 is moved upward in y-axis direction, and consequently, the image sensor 30 as the driven member Wt is moved upward in y-axis direction together with the movable base member 22.

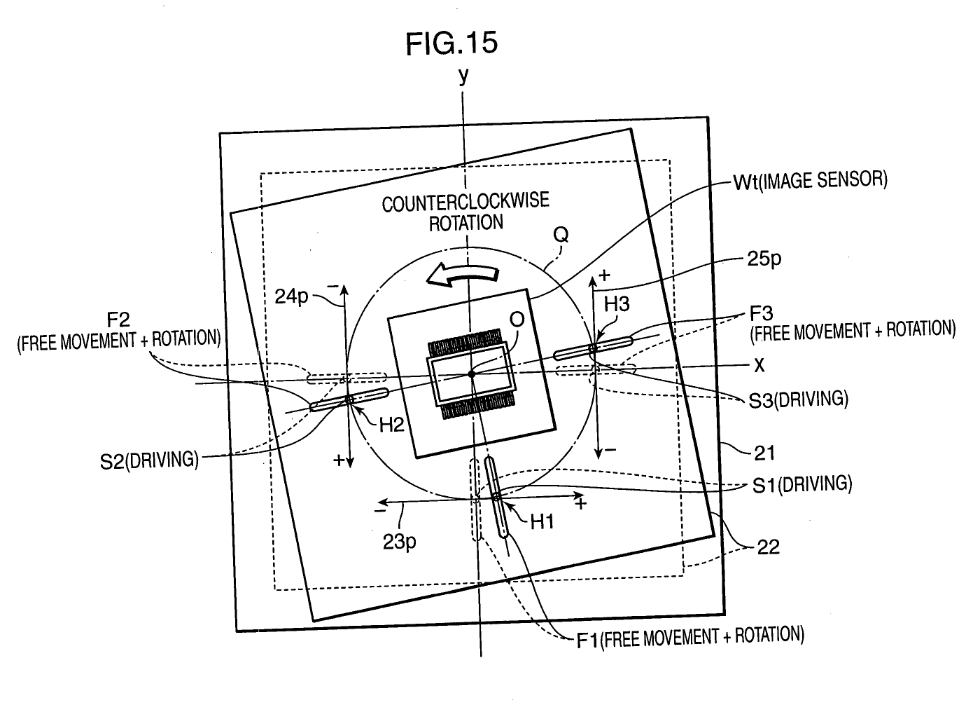

FIG. 15 is an illustration schematically showing a state that the movable base member 22 is rotated in θ-direction (counterclockwise direction). In this case, all the operating parts S1, S2, and S3 (pins 236, 246, and 256) of the first, the second, and the third driving devices 23, 24, and 25 make +driving. Specifically, the operating part S1 of the first driving device 23 makes +driving along the linear driving axis 23p, the operating part S2 of the second driving device 24 makes +driving along the linear driving axis 24p, and the operating part, S3 of the third driving device 25 makes +driving along the linear driving axis 25p. In this way, since the operating parts S1, S2, and S3 simultaneously exert driving forces orthogonal to each other to the operated parts H1, H2, and H3, respectively, a driving force is applied to the movable base member 22 to rotate the movable base member 22 counterclockwise, wherein the center of rotation of the movable base member 22 coincides with the center point O since all the driving forces are acted in tangential directions of the circle Q.

Since the operating parts S1, S2, and S3 make linear movements along the tangential directions of the circle Q, and the movable base member 22 makes a relative rotation, the pins 236, 246, and 256 as the operating parts S1, S2, and S3 freely and slidably moved in the first, the second, and the third slots 221, 222, and 223, respectively, relative to the movable base member 22. Specifically, the pins 236, 246, and 256 are guided along the first, the second, and the third slots 221, 222, and 223 depending on a rotation amount of the movable base member 22 by respective differences between the trajectory of the circle Q and the tangential lines of the circle Q (linear driving axes 23p, 24p, and 25p). Further, the pins 236, 246, and 256 make relative rotation along the first, the second, and the third slots 221, 222, and 223 depending on an angular displacement of the movable base member 22. By the above operations, the movable base member 22 is rotated counterclockwise relative to the fixed base member 21, and as a result, the image sensor 30 as the driven member Wt is moved counterclockwise with the movable base member 22.

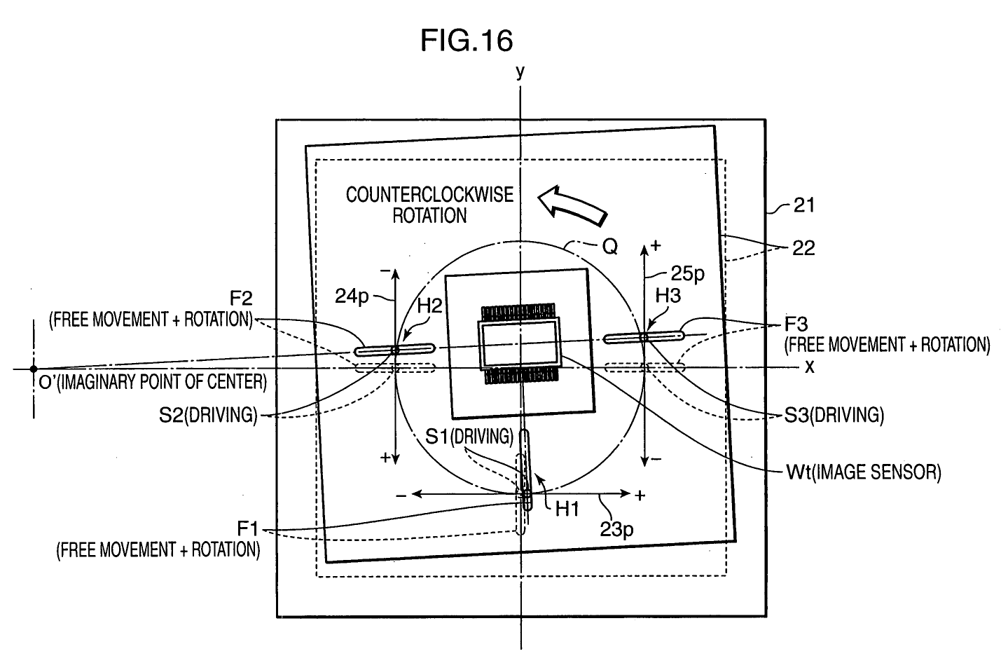

FIG. 15 shows a case that the movable base member 22 is rotated around the center point O on the fixed base member 21. Alternatively, as shown in FIG. 16, the movable base member 22 may be rotated around an imaginary center point O′ defined outside the fixed base member 21. In such an altered arrangement, it is preferable that the respective moving amounts of the operating parts S1, S2, and S3 be regulated individually depending on a distance from the imaginary center point O′ to each of the operating parts S1, S2, and S3, in place of using the same moving amount with respect to the operating parts S1, S2, and S3.

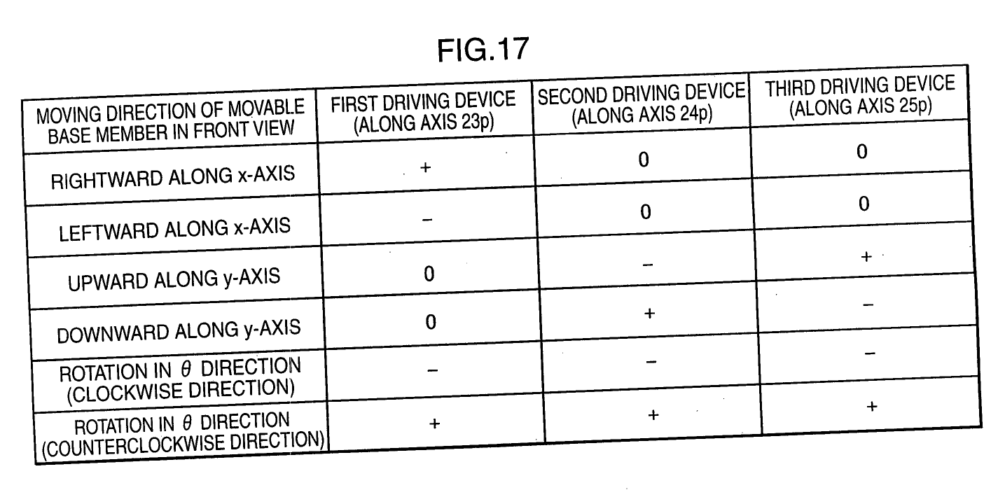

FIG. 17 is a table showing relationships between moving directions of the movable base member 22 of the moving mechanism 200, and driving directions of the operating parts S1, S2, and S3 of the first, the second, and the third driving devices 23, 24, and 25. In the table, the symbol “+” represents +driving along the linear driving axis 23p, 24p, or 25p, the symbol “−” represents −driving along the linear driving axis 23p, 24p, or 25p, and the symbol “0” represents that the operating part S1, S2, or S3 is kept unmoved. By causing the drive controller 26 to generate drive control signals as shown in FIG. 17 for driving the pulse motors 233, 243, and 253, the image sensor 30 as the driven member Wt can be rotated in θ-direction, as well as being linearly moved in x-axis direction and y-axis direction.

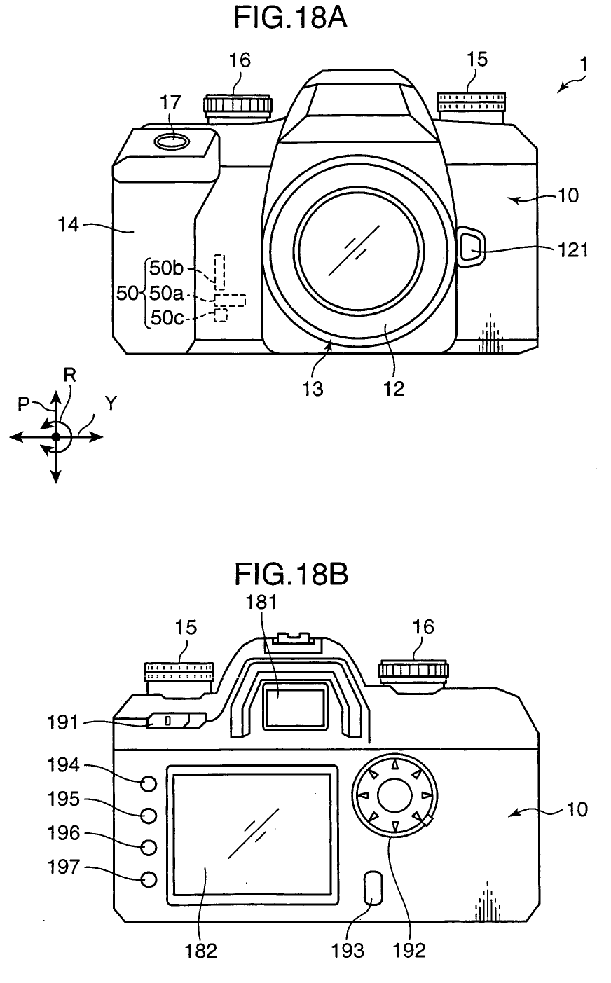

Next, an embodiment of a digital camera incorporated with the above driving mechanism as an anti-shake unit will be described. Referring to FIGS. 18A and 18B showing an external construction of the digital camera 1 embodying the present invention, wherein FIG. 18A is a front view of the digital camera 1, and FIG. 18B is a rear view of the digital camera 1, the digital camera 1 is a single lens reflex digital still camera with a taking lens 12 detachably attached substantially in the middle on a front face of a camera body 10. The taking lens 12 is exchangeable.

The camera body 10 has a mount portion 13 for mounting the taking lens 12 substantially in the middle on the front face thereof, a grip portion 14 which protrudes forward on a left end portion of the front face thereof for allowing a user to securely grip or hold the camera 1 with his or her hand, a control value setting dial 15 arranged on an upper right portion of the camera body 10 for allowing a user to set a control value, a mode setting dial 16 arranged on an upper left portion of the camera body 10 for allowing the user to switch the image shooting mode to a desired mode, and a release button 17 arranged on a top portion of the grip portion 14 for allowing the user to designate start or finish of image shooting operation (exposure).

The taking lens 12 functions as a lens aperture for passing a light image of an object to be shot, and includes a taking lens assembly, such as a zoom lens block or a fixed lens block arrayed in series along an optical axis, for guiding the light onto the image sensor 30 and a viewfinder section 7, which are arranged inside the camera body 10 and will be described later. The taking lens 12 can execute focus control by moving the positions of the respective lens elements manually or automatically.

A detachment button 121 for allowing the user to detachably attach the taking lens 12, plural electric contacts (not shown) for electrically connecting the taking lens 12 with the camera body 10, and plural couplers (not shown) for mechanically connecting the taking lens 12 with the camera body 10 are provided in the vicinity of the mount portion 13. The electric contacts are adapted to send information inherent to the taking lens 12, such as f-number and focal length, from a lens read-only-memory (lens ROM) built in the taking lens 12 to a main controller in the camera body 10, and to send information regarding the positions of the focus lens and the zoom lens in the taking lens 12 to the main controller. The couplers are adapted to transmit a driving force of a drive motor provided in the camera body 10 for driving the focus lens to the respective lenses in the taking lens 12.

Referring to FIG. 18A, a battery chamber and a card chamber are formed in the grip portion 14. A predetermined number of batteries, such as AA size batteries are housed in the battery chamber as a power source for the camera. A recording medium for recording image data of shot images, e.g., a memory card is detachably mountable in the card chamber.

The control value setting dial 15 is adapted to set various control values in image shooting. The mode setting dial 16 is adapted to set various image shooting modes such as auto-exposure (AE) control mode, auto-focusing (AF) control mode, still image shooting mode for shooting still images, moving image shooting mode (continuous shooting mode) for shooting moving images, and flash mode.

The release button 17 is a depressing type switch, and is settable to a halfway pressed state where the release button 17 is pressed halfway down, and to a fully pressed state where the release button 17 is pressed fully down. When the release button 17 is pressed halfway down in the still image shooting mode, a preparatory operation for shooting a still image of an object such as setting an exposure control value and focal adjustment is executed. Subsequently, when the release button 17 is pressed fully down, an image shooting operation, namely, a series of operations comprising exposing a color image sensor, applying a predetermined image processing to image signals acquired by the exposure, and recording the processed signals in the memory card, are executed. On the other hand, when the release button 17 is pressed fully down in the moving image shooting mode, an image shooting operation, namely, a series of operations comprising exposing the color image sensor, processing image signals acquired by the exposure, and recording the processed signals in the memory card, are executed. Subsequently, when the release button 17 is pressed fully down again, the shooting operation is terminated.

Referring to FIG. 18B, a viewfinder window (eyepiece portion) 181 is formed in an upper portion substantially in the middle on the rear face of the camera body 10. The light image of the object passing through the taking lens 12 is guided to the viewfinder window 181. A user (photographer) can view the object image through the viewfinder window 181. An external display section 182 such as an LCD monitor is provided substantially in the middle on the rear face of the camera body 10. The external display section 182 is a color liquid crystal display device having pixels in the number of 400 (in X-direction corresponding to horizontal direction)×300 (in Y-direction corresponding to vertical direction)=120,000 in this embodiment, and is adapted to display a menu screen for allowing the user to set the AE/AF control mode, still image/moving image shooting mode, or other shooting conditions, and to display shot images that have been recorded in the memory card for playback in the playback mode, as well as displaying the moving images.

A power switch 191 comprised of a 2-contact slide switch is provided on an upper left portion of the external display section 182. A direction selecting key 192 and an anti-shake switch 193 are provided on the right side of the external display section 182. The direction selecting key 192 is a circular operation button. Upward, downward, leftward, and rightward directions, and upward right, upward left, downward right, and downward left directions are detectable with use of the direction selecting key 192. The direction selecting key 192 has multi-functions. For instance, the direction selecting key 192 functions as an operation switch for allowing the user to alter the item selected on the menu screen displayed on the external display section 182 for setting a desired shooting scene, and also functions as an operation switch for allowing the user to alter the selected frame of an image for playback on an index image screen where plural thumbnail images are displayed in a certain order. The direction selecting key 192 also functions as a zoom switch for allowing the user to change the focal length of the zoom lens of the taking lens 12.

The anti-shake switch 193 is adapted to set an anti-shake mode that enables to perform shooting free of image blur even in a condition that such an image blur may take place due to shake of the camera body 10 or the like, e.g., one-hand shooting, telephotographing, or shooting in a dark place where long time exposure is required. When the anti-shake switch 193 is turned on, anti-shake operation of the image sensor 30 by the anti-shake unit 20, which will be described later, is executable.

A cancel switch 194, a determination switch 195, a menu display switch 196, and an external display changeover switch 197 are provided on the left side of the external display section 182 for allowing the user to designate display on the external display section 182 and to manipulate display contents displayed on the external display section 182. The cancel switch 194 is a switch for allowing the user to cancel the contents selected on the menu screen. The determination switch 195 is a switch for allowing the user to determine the contents selected on the menu screen. The menu display switch 196 is a switch for allowing the user to display the menu screen on the external display section 182 or to change over the contents of the menu screen between a shooting scene setting screen and a mode setting screen regarding exposure control, for instance. Each time the menu display switch 196 is depressed, the contents of the menu screen is changed. The external display changeover switch 197 is a switch for allowing the user to turn on and off the display of the external display section 182. Each time the external display changeover switch 197 is depressed, display on the external display section 182 is alternately turned on and off.

Regarding the swinging direction of the digital camera 1, as shown in FIG. 18A, when horizontal direction of the digital camera 1 is defined as X-axis, vertical direction thereof is defined as Y-axis, and direction of the optical axis L is defined as Z-axis, then, rotation around the X-axis (up and down movements in terms of shake) is represented as shake in a pitch direction shown by the arrow P in FIG. 18A, rotation around the Y-axis (leftward and rightward movements in terms of shake) is represented as shake in a yaw direction shown by the arrow Y in FIG. 18A, and rotation around the Z-axis (clockwise and counterclockwise rotations in terms of shake) is represented as shake in a rolling direction shown by the arrow R in FIG. 18A. The digital camera 1 is incorporated with a shake detecting section 50 including a pitch gyro 50a for detecting shake in the pitch direction, a yaw gyro 50b for detecting shake in the yaw direction, and a rolling gyro 50c for detecting shake in the rolling direction to detect shake imparted to the digital camera 1.

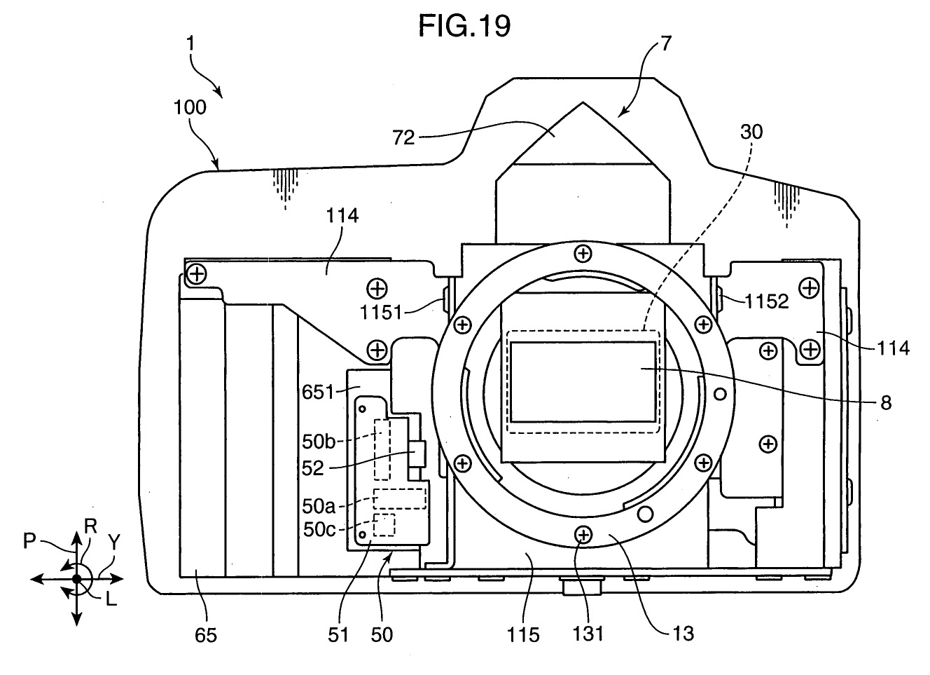

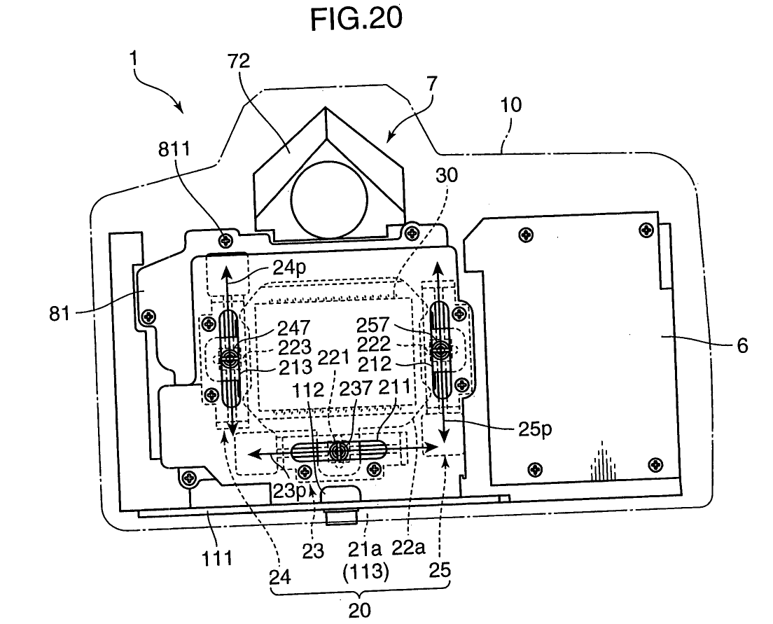

Next, an internal arrangement of the digital camera 1 is described. FIGS. 19, 20, and 21 are a perspective front view, a perspective rear view, and a cross-sectional side view of the digital camera 1, respectively. It should be noted that FIGS. 19 and 20 are perspective views each showing a state that the taking lens 12 is detached.

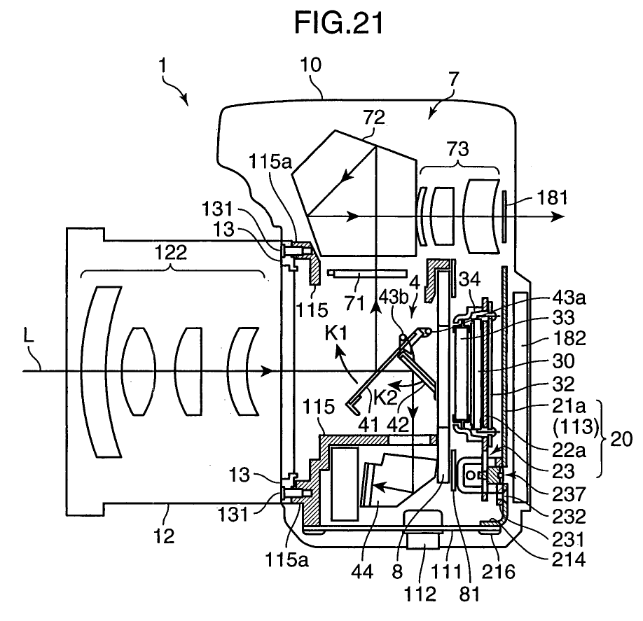

As shown in FIG. 21, the taking lens 12 is mounted on the camera body 10 of the digital camera 1. The camera body 10 accommodates therein the image sensor 30 of a rectangular shape in plan view for converting a light image of an object into an electrical signal, the anti-shake unit 20 including a driving section constituted of the first, the second, and the third driving devices 23, 24, and 25 for applying an swinging force to the image sensor 30 to oscillate the image sensor 30 in the pitch direction, the yaw direction, and the rolling direction shown in FIG. 18A in a direction perpendicular to the optical axis L, a mirror section 4, the shake detecting section 50, a control circuit board 6 on which electronic components such as an ASIC provided with various circuits for image processing, and a driving control circuit are mounted, the battery chamber 65, a viewfinder section 7 for allowing the user to confirm a field of view, a frame member 115 for encasing the mirror section 4, a shutter 8, and the other parts in such a manner that these parts are fixedly and integrally supported on a bottom chassis 111, a side chassis 113, a front chassis 114, and the like. The image sensor 30 and part of the anti-shake unit 20 are not rigidly fixed to these chassis to allow the image sensor 30 and the part of the anti-shake unit 20 to freely oscillate. A screw portion 112 is formed in the bottom chassis 111 for mounting a tripod.

As shown in FIGS. 19 and 21, the image sensor 30 is arranged at an appropriate position on the optical axis L (see FIG. 21) of a lens group 122 of the taking lens 12 in the camera body 10 as opposed to the taking lens 12 which is detachably attached to the camera body 10, with a sensing plane thereof extending in a direction perpendicular to the optical axis L.

The image sensor 30 is adapted to detect brightness of an object to be shot, namely, to capture a light image of the object. Specifically, the image sensor 30 photoelectrically converts the object light image formed through the taking lens 12 into image signals of color components of red (R), green (G), and blue (B) based on the received light amount of the object light image for outputting the signals to the ASIC of the control circuit board 6 or the like. More specifically, the image sensor 30 has a rectangular shape in plan view, and comprises a single CCD color area sensor of a so-called “Bayer matrix” in which patches of color filters each in red (R), green (G), and blue (B) are attached on respective surfaces of charge coupled devices (CCDs) in a checker pattern, e.g., 3,000 in X-direction and 2,000 in Y-direction, namely, 6,000,000 pixels in total. The image sensor 30 may have a shape other than the rectangular shape. Examples of the image sensor 30 are a CCD image sensor, a CMOS image sensor, and a VMIS image sensor. In this embodiment, a CCD image sensor is used as the image sensor 30.

The anti-shake unit 20 is adapted to correct misalignment of the optical axis L by moving or swinging the image sensor 30 depending on a shake of the camera body 10 in the case where an external force is applied to the camera body 10 by the user. The anti-shake unit 20 has a construction similar to that of the driving mechanism 200 (anti-shake unit 20), which has been described in the foregoing section referring to FIGS. 6 through 17, and is comprised of a fixed base member 21a, a movable base member 22a, first, second, and third driving devices 23, 24, and 25. The construction of the anti-shake unit 20 will be described later in detail.

The frame member (front frame) 115 is arranged substantially in the middle of the camera body 10. The frame member 115 has a box-like structure having a substantially square shape in front view with an opening formed in an upper portion thereof as opposed to the viewfinder section 7. The frame member 115 has a sufficient rigidity against flexure or a like external force. The frame member 115 has a cylindrical mount receiving portion 115a having a configuration substantially identical to the shape of the mount portion 13. The mount portion 13 is fittingly received in the mount receiving portion 115a, and is fixed thereto by plural screws 131. The frame member 115 is fixed to a bent portion of the front chassis 114 at fixing portions formed on side portions of the frame member 115 near the mount receiving portion 115a by screws 1151, 1152, respectively. (See FIG. 19).

Referring to FIG. 21, the mirror section (reflective plate) 4 is arranged on the optical axis L at such a position as to reflect the object light image toward the viewfinder section (viewfinder optical system) 7. The object light image that has passed through the taking lens 12 is reflected upward by the mirror section 4, specifically by a main mirror 41 to be described later, and reaches a focusing glass 71. Part of the object light image that has passed through the taking lens 12 is transmitted through the mirror section 4. The mirror section 4 is arranged inside the frame member 115 and is supported by the frame member 115 by an unillustrated support mechanism.

The mirror section 4 includes the main mirror 41 and a sub mirror 42. The sub mirror 42 is arranged on the rear side of the main mirror 41 and is rotatably tilted toward the rear surface of the main mirror 41. Part of the object light image passing through the main mirror 41 is reflected on the sub mirror 42, and the reflected object light image is incident onto a focus detecting section 44. The focus detecting section 44 is a so-called AF sensor constituted of a metering device or the like for detecting information as to whether the object light image has been focused.

The mirror section 4 is a so-called quick return mirror. During exposure, the mirror section 4 is quickly pivoted upward in the direction shown by the arrow K1 in FIG. 21 about the axis of a shaft 43a, and is retained at a certain position below the focusing glass 71. At this time, the sub mirror 42 is pivoted in the direction shown by the arrow K2 in FIG. 21 about the axis of a shaft 43b on the rear side of the main mirror 41. When the main mirror 41 is retained at the position below the focusing glass 71, the sub mirror 42 is folded substantially in parallel with the main mirror 41. As a result, the object light image is captured on the sensing plane of the image sensor 30 passing through the taking lens 12 without being blocked by the mirror section 4 for exposure. When the exposure is finished, the mirror section 4 is returned to the initial position shown by the solid line in FIG. 21.

As shown in FIG. 19, the shake detecting section 50 includes the pitch gyro 50a, the yaw gyro 50b, the rolling gyro 50c, a gyro plate 51, and a flexible wiring substrate 53 for the gyros. The pitch gyro 50a, the yaw gyro 50b, and the rolling gyro 50c are each adapted to detect an angular velocity of an object to be measured (in this embodiment, the camera body 10) when the camera body 10 is swung by an impact applied to the camera body 10. An exemplified gyro is constructed such that a certain voltage is applied to a piezoelectric device to oscillate the piezoelectric device, and distortion arising from Coriolis action that is generated when an angular velocity due to swing of the camera body 10 is applied to the swinging piezoelectric device is read as an electric signal.

The pitch gyro 50a, the yaw gyro 50b, and the rolling gyro 50c are mounted on the gyro plate 51, and attached to a planar-shaped gyro mounting portion 651 formed on a side wall of the battery chamber 65 via a shock absorber or the like. The shock absorber is adapted to keep the gyros from erroneously detecting vibration of the mirror section 4, and may be a sheet member made of butyl rubber formed with adhesive layers on both surfaces thereof. The flexible wiring substrate 52 is adapted to electrically connect the pitch gyro 50a, the yaw gyro 50b, and the rolling gyro 50c with the control circuit board 6.

The control circuit board 6 and the anti-shake unit 20 are arranged in proximity to each other on planes substantially identical to each other. The control circuit board 6 and the image sensor 30 are electrically connected with each other by an unillustrated flexible wiring substrate or the like. The battery chamber 65 is arranged on the same side as the grip portion 14 of the camera body 10, and is made of a resin molded material such as a plastic. A predetermined number of batteries, such as AA size batteries, are housed in the battery chamber 65 as a power source for driving the digital camera 1. The card chamber (not shown) is formed in the rear portion of the battery chamber 65 for detachably attaching a memory card or a like device to record image data of shot images therein.

The viewfinder section 7 is arranged above the frame member 115. The viewfinder section 7 includes a penta prism 72, an eyepiece lens 73, and the viewfinder window 181. The penta prism 72 has a pentagonal shape in cross section, and is a prism member for forming the object light image that has been incident onto the viewfinder section 7 from the lower part thereof into an upright image by turning the light image upside down through internal reflection. The eyepiece lens 73 guides the upright object light image outside of the camera body 10 through the viewfinder window 181. With this arrangement, the viewfinder section 7 functions as an optical viewfinder during a shooting standby operation.

A low-pass filter (optical filter) 33 is arranged on the optical axis L in front of the image sensor 30 to prevent pseudo color image formation or generation of moiré in color images. The low pass filter 33 is supported on the image sensor holder 34 together with the image sensor 30. The external display section 182 is arranged behind the image sensor 30 in parallel therewith, with the side chassis 113 (fixed base member 21a) interposing between the external display section 182 and the image sensor 30.

The shutter 8 as a mechanical shutter is arranged in front of the low pass filter 33. The shutter 8 is controllably opened and closed as timed with the exposure. In this embodiment, the shutter 8 is, for instance, a vertically traveling focal plane shutter, with a forward portion thereof being brought into contact with a rear end portion of the frame member 115, and a rear portion thereof being pressed against a shutter pressing plate 81. The shutter pressing plate 81 is fixed to the frame member 115 by a screw 811 (see FIG. 20). With this arrangement, the shutter 8 is supported on the rigid frame member 115.

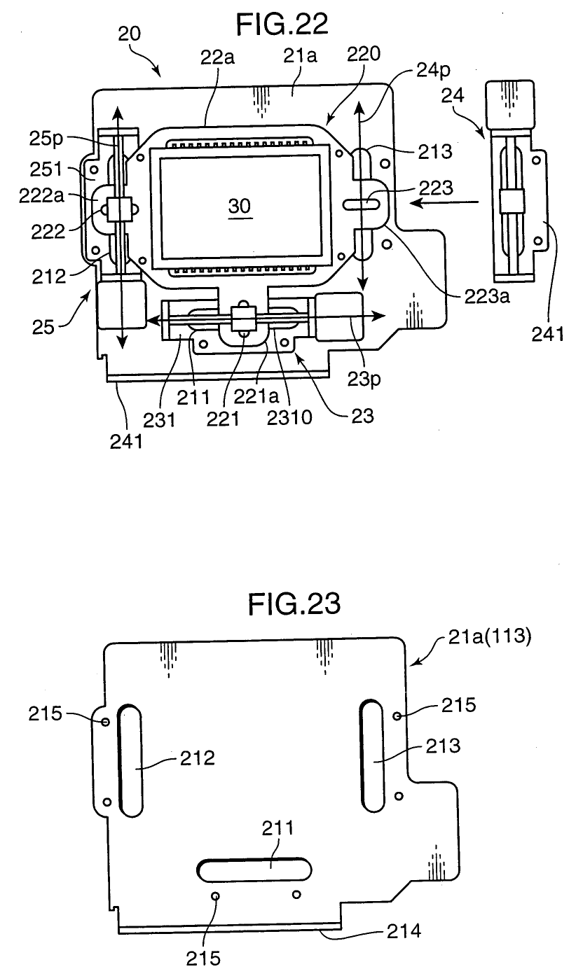

In this section, the ant-shake unit 20 in the embodiment of the present invention is described. FIG. 22 is a plan view of the anti-shake unit 20 as viewed from the direction of the taking lens 12, with illustration of the camera body 10 being omitted. The anti-shake unit 20 comprises the fixed base member 21a and the movable base member 22a, and further comprises a movable base member unit 220 which is moved relative to the fixed base member 21a, and the first, the second, and the third driving devices 23, 24, and 25 loaded on the fixed base member 21a.

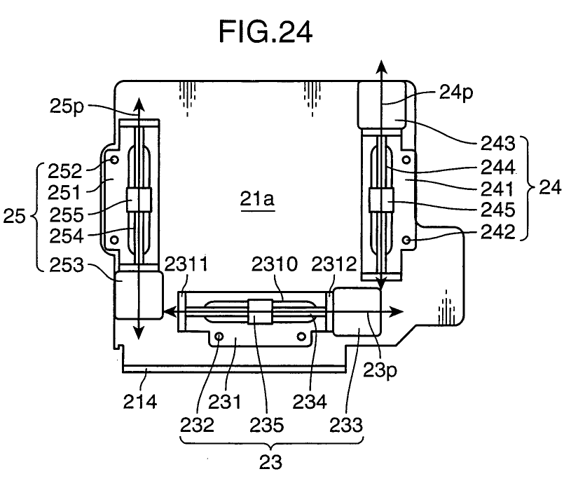

FIG. 23 is a plan view of the fixed base member 21a also serving as the side chassis 113. FIG. 24 is a plan view of the fixed base member 21a with the first, the second, and the third driving devices 23, 24, and 25 being mounted thereon. Similarly to the fixed base member 21 shown in FIG. 8, the fixed base member 21a is formed with three linear slots (first, second, and third slots 211, 212, and 213). The first slot 211 is a slot extending in a horizontal direction (yaw direction shown in FIG. 18A) of the digital camera 1, and the second and the third slots 212 and 213 each is a slot extending in a vertical direction (pitch direction shown in FIG. 18A) of the digital camera 1.

A bent portion 214 is formed on a lower part of the fixed base member 21a for fixing the fixed base member 21a as the side chassis 213 to the bottom chassis 111 by a screw 216. Screw holes 215 are formed in the fixed base member 21a near the first, the second, and the third slots 211, 212, 213 to fasten frame members 231, 241, and 251 of first, the second, and the third driving devices 23, 24, and 25 to the fixed base member 21a by screws 232, 242, and 252, respectively. As shown in FIG. 24, the first, the second, and the third driving devices 23, 24, and 25 are mounted on the fixed base member 21a, so that the first, the second, and the third driving devices 23, 24, 25 extend along the first, the second, and the third slots 211, 212, and 213, respectively. Thereby, linear driving axes 23p, 24p, and 25p are defined. Since the constructions of the first, the second, and the third driving devices 23, 24, and 25, and the linear driving axes 23p, 24p, and 25p are substantially the same as those in the foregoing section described referring to FIG. 6, description thereof will be omitted herein.

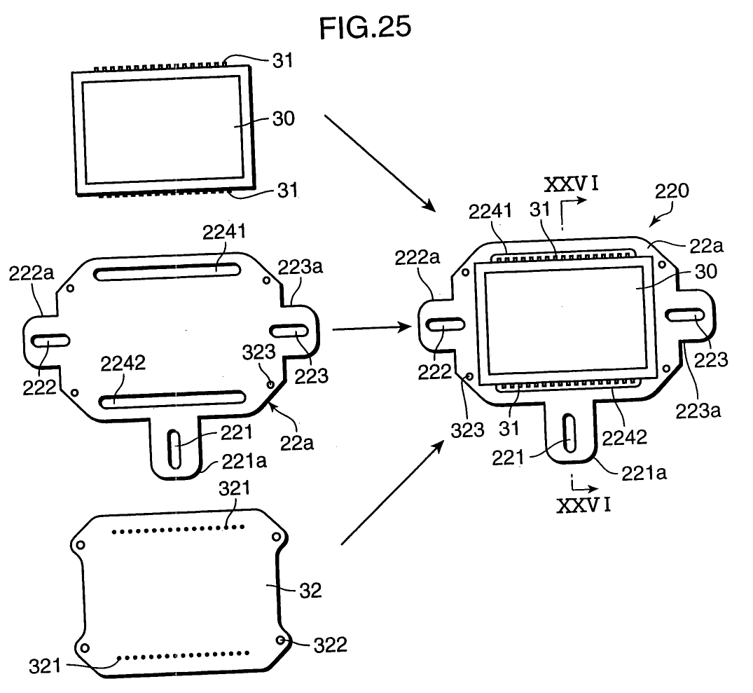

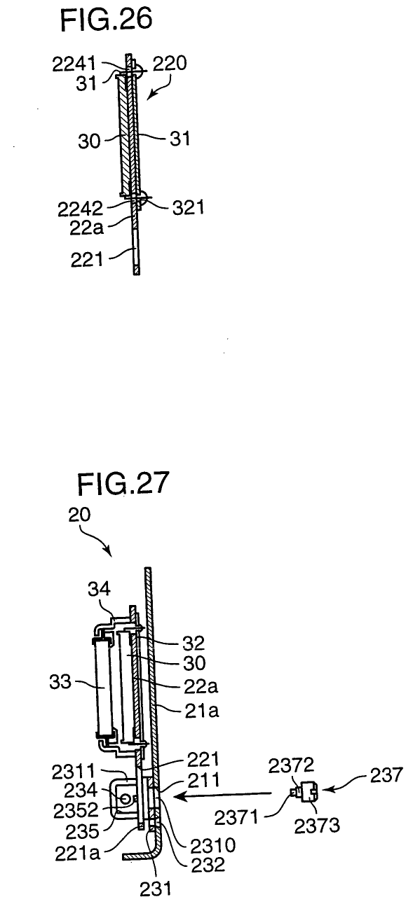

FIG. 25 is a plan view of the movable base member unit 220 in an assembled state, as well as respective parts constituting the movable base member unit 220 before being assembled. FIG. 26 is a cross-sectional view taken along the line XXVI-XXVI in FIG. 25, namely, a cross-sectional side view of the movable base member unit 220. The movable base member unit 220 is an assembly constituted of the movable base member 22a, the image sensor 30, and an image sensor bedplate 32.

Three linear slots (first, second, and third slots 221, 222, and 223) are formed in the movable base member 22a in a similar manner as the movable base member 22 shown in FIG. 8. In FIG. 8, the rectangular movable base member 22 is described. In this embodiment, the movable base member 22a has a main body of an oval shape or octagonal shape, with three flange portions 221a, 222a, and 223a protruding from the oval-shaped body, and the first, the second, and the third slots 221, 222, and 223 are formed in the flange portions 221a, 222a, and 223a, respectively. The first, the second, and the third slots 221, 222, and 223 extend in directions orthogonal to the first, the second, and the third slots 211, 212, and 213 formed in the fixed base member 21a, respectively. The first, the second, and the third slots 221, 222, and 223 function as moving guide parts for causing relative rotation of operating parts of the first, the second, and the third driving devices 23, 24, 25, respectively.

In addition to the above, elongated openings 2241 and 2242 are formed at appropriate positions in upper and lower parts of the movable base member 22a, respectively to pass through arrays of lead frames 31 exposing from upper and lower sides of the image sensor 30. With this arrangement, the image sensor 30 is mounted in close contact with the movable base member 22a in a state that the extending directions of the elongated openings 2241 and 2242 coincide with the upper and lower sides of the image sensor 30 along which the lead frames 31 are arrayed. The movable base member 22a also serves as a heat releaser of the image sensor 30, and is made of a metal plate having good heat conductance to efficiently release heat. Four screw holes 323 are formed at respective corner portions of the movable base member 22a for mounting the image sensor bedplate 32 onto the movable base member 22a.

A multitude of lead holes 321 for solder connecting the lead frames 31, and four screw holes 322 for mounting the image sensor bed plate 32 onto the movable base member 22a are formed in the image sensor bedplate 32. The image sensor bedplate 32 is attached to a surface of the movable base member 22a in close contact therewith, on the side opposite to the side where the image sensor 30 is mounted. As shown in FIG. 26, the movable base member unit 220 has an overlay structure, wherein the image sensor 30 is mounted on the front face (side of the taking lens 12) of the movable base member 22a, and the image sensor bedplate 32 is mounted on the back face of-the movable base member 22a.

Next, an arrangement as to how the fixed base member 21a, the movable base member 22a (movable base member unit 220), the first, the second, and the third driving devices 23, 24, and 25 are assembled to each other is described. Similarly to the arrangement shown in FIG. 8, the fixed base member 21a and the movable base member 22a are placed one over the other in such a manner that the first, the second, and the third slots 211, 212, and 213 of the fixed base member 21a extend orthogonal to the first, the second, and the third slots 221, 222, and 223 of the movable base member 22a to make cross shapes in front view, respectively. The anti-shake unit 20 in this embodiment is different from that in FIG. 8 in that the frame members 231, 241, and 251 of the first, the second, and the third driving devices 23, 24, and 25 are interposed between the fixed base member 21a and the movable base member 22a (flange portions 221a, 222a, and 223a) (see FIGS. 21, 22 and 27). Specifically, as shown in FIG. 27, which is a cross-sectional side view of the anti-shake unit 20, the flange portion 221a of the movable base member 22a is arranged in close contact with the movable slider 235, and is guided and retained by a retaining pin unit 237.

The retaining pin unit 237 has a retaining portion 2371, a drive stem portion 2372, and a guide stem portion 2373. The retaining pin unit 237 of the first driving device 23 is described as a representative of the retaining pin unit. The retaining portion 2371 is meshed with a screw hole 2352 formed in the movable slider 235 to integrally move the movable slider 235 with the retaining pin unit 237. The drive stem portion 2372 has a cylindrical shape to be fitted in the first slot 221 of the movable base member 22a, and has an outer diameter slightly smaller than the width of the first slot 221. The guide stem portion 2373 has a cylindrical shape to be fitted in the elongated opening 2310 of the frame member 231, and has an outer diameter substantially equal to the width of the elongated opening 2310 and larger than the width of the first slot 221. In this arrangement, the guide stem portion 2373 securely retains the flange portion 221a of the movable base member 22a. Similarly to the retaining pin unit 237 of the first driving device 23, guiding and retaining are secured by retaining pin units 247 and 257 of the second and third driving devices 24 and 25.

The drive stem portion 2372 corresponds to the pin 236 serving as the operating part S1, which has been described in the foregoing section referring to FIG. 6 and other relevant drawings. The drive stem portion 2372 applies a driving force to the movable base member 22a through the first slot 221 of the movable base member 22a. Further, the drive stem portion 2372 is guided in the first slot 221 along the longitudinal direction thereof, namely, along the direction of the guide axis thereof for causing relative rotation of the movable base member 22a.

The guide stem portion 2373 corresponds to the guide portion 2351, which has been described referring to FIG. 10 and other relevant drawings. Rotation of the movable slider 235 around the axis of the driving shaft 234 is restrained by engagement of the guide stem portion 2373 in the elongated opening 2310. As a result, the movable slider 235 (drive stem portion 2372) linearly reciprocates exclusively along the longitudinal direction of the elongated opening 2310, namely, in the extending direction of the first slot 211. The operations of the second and the third driving devices 24 and 25 are the same as the operation of the first driving device 23.

As shown in FIG. 27, the low-pass filter 33 is integrally loaded with the aforementioned parts on the anti-shake unit 20. The low-pass filter 33 is integrally retained with the image sensor 30 on the movable base member 22a by an image sensor holder 34. Namely, the low-pass filter 33 is integrally oscillated with the image sensor 30.

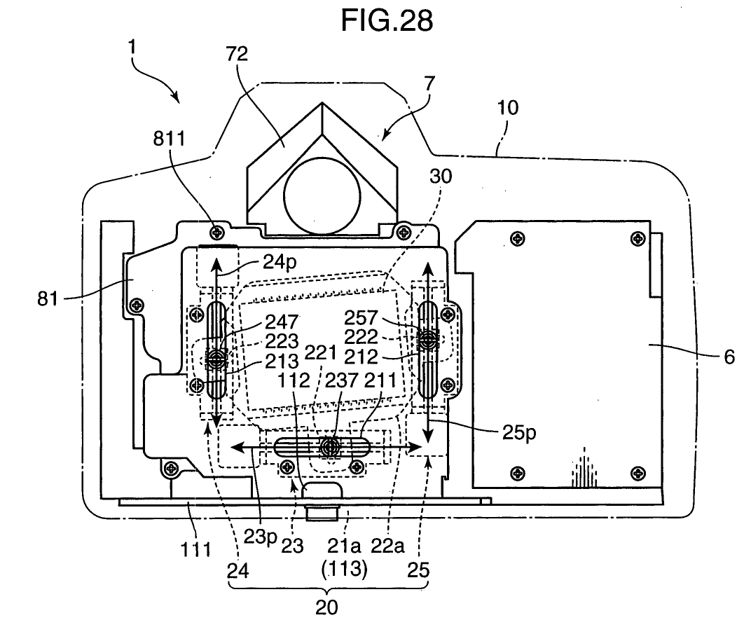

With use of the anti-shake unit 20 having the above construction, the movable base member unit 220 (image sensor 30) is moved in the pitch direction, the yaw direction, and the rolling direction in a similar manner as in the foregoing section, wherein the operation of the movable base member 22 has been described based on FIGS. 13 through 16. Specifically, the image sensor 30 loaded on the movable base member 22a is moved in the pitch direction, the yaw direction, and the rolling direction for shake correction by + driving or − driving of the first, the second, and the third driving devices 23, 24, and 25 along the linear guide axes 23a, 24a, and 25a. Since the mechanism as to how the image sensor 30 is moved for shake correction is the same as the mechanism described based on FIGS. 13 through 16, description thereof is omitted herein. FIG. 28 is an illustration of the digital camera 1 showing a state that the movable base member unit 220 (image sensor 30) is rotated in a rolling direction (counterclockwise direction).

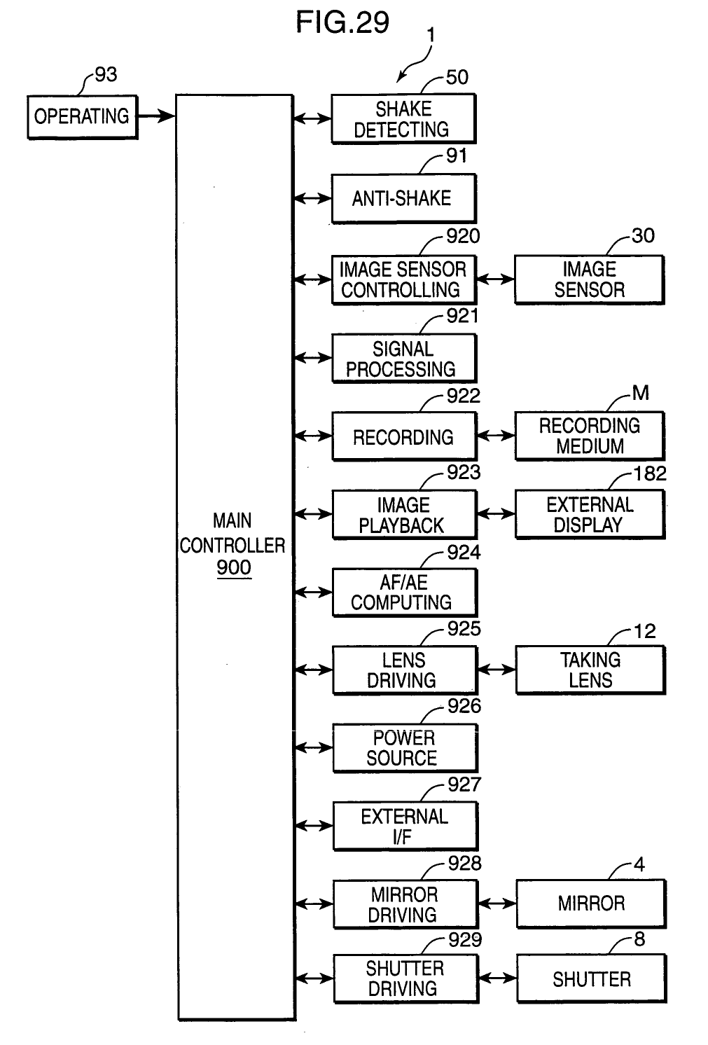

Now, an electrical configuration of the digital camera 1 in this embodiment is described. FIG. 29 is a block diagram showing the electrical configuration of the digital camera 1. As shown in FIG. 29, the digital camera 1 comprises the main controller 900, the shake detecting section 50, an anti-shake section 91, an image sensor controlling section 920, a signal processing section 921, a recording section 922, an image playback section 923, an AF/AE computing section 924, a lens driving section 925, a power source section 926, an external interface (I/F) section 927, a mirror driving section 928, a shutter driving section 929, and an operating section 93 including the mode setting dial 16 and the release button 17.

The main controller 900 includes a read only memory (ROM) in which various control programs are stored, a random access memory (RAM) for temporarily storing data concerning calculation results and control processing, and a central processing unit (CPU) for reading the control program and the like from the ROM for execution. The main controller 900 controls operations of the respective parts of the digital camera 1 in response to receiving various signals from the anti-shake section 91, the operating section 93, the driving section and the like.

As mentioned above, the shake detecting section 50 is provided with the pitch gyro 50a, the yaw gyro 50b, and the rolling gyro 50c (see FIG. 19) for detecting shake of the camera body 10. The anti-shake section 91 is adapted to calculate moving amounts of the image sensor 30 to be moved by the movable sliders 235, 245, and 255 (retaining pin units 237, 247, and 257) of the first, the second, and the third driving devices 23, 24, and 25, based on information concerning the shake of the camera body 10 detected by the shake detecting section 50, and information concerning the current position of the image sensor 30 detected by a position detecting section 55.

The image sensor controlling section 920 controls photoelectric conversion of the image sensor (CCD sensor) 30, and applies a predetermined analog processing such as gain control to an output signal outputted from the image sensor 30. Specifically, in response to a drive control signal outputted from a timing generator provided in the image sensor controlling section 920, the image sensor 30 is exposed to light from an object for a predetermined duration for converting the received light amount to an image signal, which is sent to the signal processing section 921 after gain control.

The signal processing section 921 applies predetermined analog signal processing and digital signal processing to the image signal outputted from the image sensor 30. The signal processing section 921 includes an analog signal processing circuit, and various digital signal processing circuits. The analog signal processing circuit includes a correlated double sampling (CDS) circuit for reducing noises in sampling of image signals, and an auto gain control (AGC) circuit for adjusting the level of the image signal, and applies a predetermined analog processing to an analog image signal outputted from the image sensor 30. The analog image signal outputted from the analog signal processing circuit is converted to a digital image signal by an analog-to-digital (A/D) conversion circuit for outputting the digital image signal to the digital signal processing circuit. The digital signal processing circuit includes an interpolation circuit for interpolating the A/D converted pixel data, a black level compensation circuit for compensating the black level of the respective A/D pixel data to a reference black level, a white balance (WB) circuit for adjusting white balance of the image data, and a gamma correction circuit for correcting gradations by correcting gamma characteristics of the respective pixel data. Further, the signal processing circuit 921 has an image memory for temporarily storing the image data after the signal processing.

The recording section 922 records the generated image data into a detachably attachable recording medium M such as a memory card, and reads out the image data stored in the recording medium M. The image playback section 923 processes the image data generated in the signal processing section 921, or the image data read out from the recording medium M by the recording section 922, and generates image data suitable for display on the external display section 182.

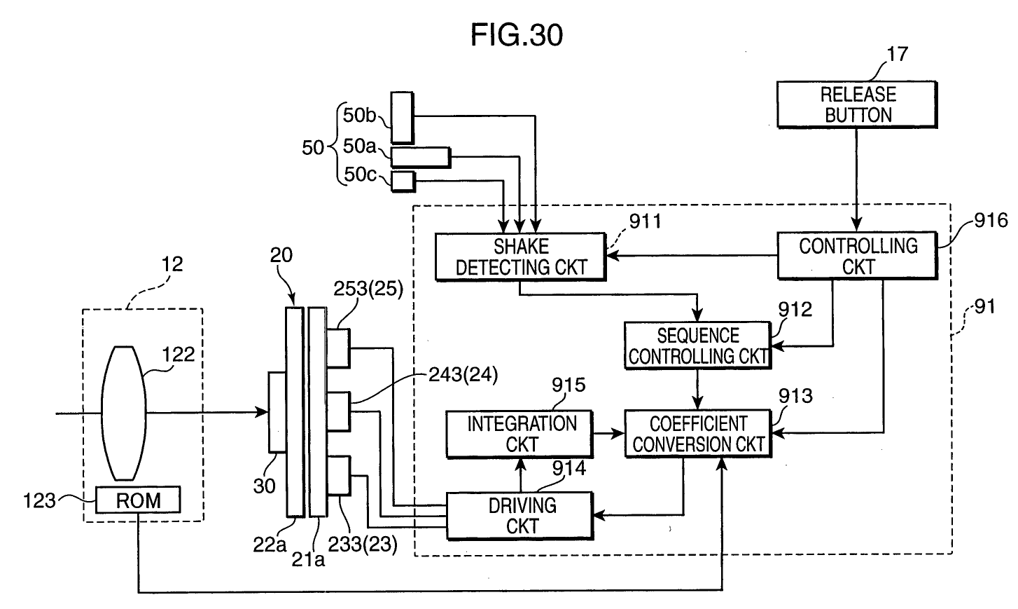

The AF/AE computing section 924 performs computation for auto focusing (AF) control or auto exposure (AE) control. The lens driving section 925 controls driving of the lens group 122 of the taking lens 12. The taking lens 12 is provided with the focus lens, the zoom lens, the aperture for adjusting the transmissive light amount, and the lens ROM 123 (see FIG. 30) in which information inherent to the lens such as f number and focal length is stored. The lens ROM 123 is connected with the main controller 900 via the electric contacts provided on the mount portion 13.

The power source section 926 includes a battery housed in the battery chamber 65, and supplies power to the respective parts of the digital camera 1. The external I/F section 927 has a connector terminal provided with a housing for a remote terminal or a USB terminal, or with an input jack of an AC power source, and establishes an interface with an external device.

The mirror driving section 928 drives the mirror section 4 including the main mirror 41 and the sub mirror 42. The mirror driving section 928 drivingly retracts the main mirror 41 together with the sub mirror 42 from the optical axis L of the taking lens 12 by pivotally rotating the main mirror 41 based on a retraction signal outputted from the main controller 900. The retraction signal is generated in the main controller 900 in response to input of an on-signal indicative of turning on of the release button 17. Upon completion of a shooting operation, the mirror driving section 928 returns the mirror section 4 from the retracted state to an initial state where the main mirror 41 lies on the optical axis L by pivotally rotating the main mirror 41. The shutter driving section 929 drivingly opens and closes the shutter 8. The operating section 93 includes manipulation members such as the release button 17, the mode setting dial 16, the direction selecting key 192, and the anti-shake switch 193, and are used to allow the user to enter desired designation.

FIG. 30 is a block diagram schematically showing an electrical configuration of an anti-shake mechanism, including a functional block diagram of the anti-shake section 91. The anti-shake section 91 includes a shake detecting circuit 911, a coefficient conversion circuit 912, a controlling circuit 913, a driving circuit 914, an integration circuit 915, and a sequence controlling circuit 916.

An angular velocity signal indicative of oscillation of the camera body 10 in the pitch direction detected by the pitch gyro 50a, an angular velocity signal indicative of oscillation of the camera body 10 in the yaw direction detected by the yaw gyro 50b, and an angular velocity signal indicative of the camera body 10 in the rolling direction detected by the rolling gyro 50c are outputted to the shake detecting circuit 911. The shake detecting circuit 911 includes a filter circuit (low pass filter and high pass filter) for reducing noises and drifts from the detected angular velocity signals, an amplification circuit for amplifying the respective angular velocity signals, and an integration circuit for converting the respective angular velocity signals to angular signals. Specifically, the shake detecting circuit 911 reads the respective angular velocity signals at a predetermined time interval, and outputs the readout angular velocity signals as detx, dety, detz to the coefficient conversion circuit 912, where detx represents a shake amount of the camera body 10 in the yaw direction, dety represents a shake amount of the camera body 10 in the pitch direction, and detz represents a shake amount of the camera body 10 in the rolling direction.

The coefficient conversion circuit 912 converts the respective shake amounts (detx, dety, detz) outputted from the shake detecting circuit 911 to moving amounts (px, py, pz) by which the image sensor 30 is to be moved in the yaw direction, the pitch direction, and the rolling direction by the first, the second, and the third driving devices 23, 24, and 25, respectively.

The controlling circuit 913 converts the signals indicative of the respective moving amounts (px, py, pz) to actual drive signals (drvx, drvy, drvz), considering the position information of the image sensor 30, the operating characteristics of the first, the second, and the third driving devices 23, 24, and 25, and other factor. The controlling circuit 913 reads out the information relating to the focal length or the like stored in the lens ROM 123 of the taking lens 12, and generates the drive signals (drvx, drvy, drvz) depending on the focal length of the taking lens 12 actually mounted on the mount portion 13.

The driving circuit 914 generates drive pulses for actually driving the pulse motors 233, 243, and 253 of the first, the second, and the third driving devices 23, 24, and 25 based on the respective drive signals (drvx, drvy, drvz) generated in the controlling circuit 913, which are signals indicative of corrective amounts by which the image sensor 30 is to be correctively moved in the pitch, the yaw, and the rolling directions.

The integration circuit 915 is adapted to perform open loop controlling of the pulse motors 233, 243, and 253. Specifically, the integration circuit 915 integrates the drive pulse numbers generated from the driving circuit 914, generates position information concerning the respective current positions of the pulse motors 233, 243, and 253, namely, information concerning a target moving position of the image sensor 30 for shake correction, and outputs the generated position information to the controlling circuit 913.

The operations of the shake detecting circuit 911, the coefficient conversion circuit 912, and the controlling circuit 913 are controlled by the sequence controlling circuit 916. Specifically, the sequence controlling circuit 916 causes the shake detecting circuit 911 to read the data signals concerning the respective shake amounts (detx, dety, detz) in response to depressing of the release button 17. Subsequently, the sequence controlling circuit 916 controls the coefficient conversion circuit 912 to convert the respective shake amounts to the moving amounts (px, py, pz), and causes the controlling circuit 913 to calculate a corrective amount by which the image sensor 30 is to be correctively moved, based on the respective moving amounts (px, py, pz). The above operations are cyclically repeated at a predetermined time interval from start of depressing the release button 17 until exposure is terminated while the anti-shake switch 193 is kept in an ON-state for allowing the anti-shake unit 20 to move the image sensor 30 for shake correction.

In the case where piezoelectric actuators or an equivalent device are used as drive sources for the first, the second, and the third driving devices 23, 24, and 25 in place of the pulse motors, it is preferable to provide two 2-dimensional hall sensors to acquire the current position information of the movable base member 22a (image sensor 30) for detecting parallel movement and rotational movement of the image sensor 30. Further, it is preferable to provide a position detecting circuit for detecting output voltages of the respective hall sensors and computing the current position of the image sensor 30 to output the computation result representing the current position of the image sensor 30 to the controlling circuit 913.

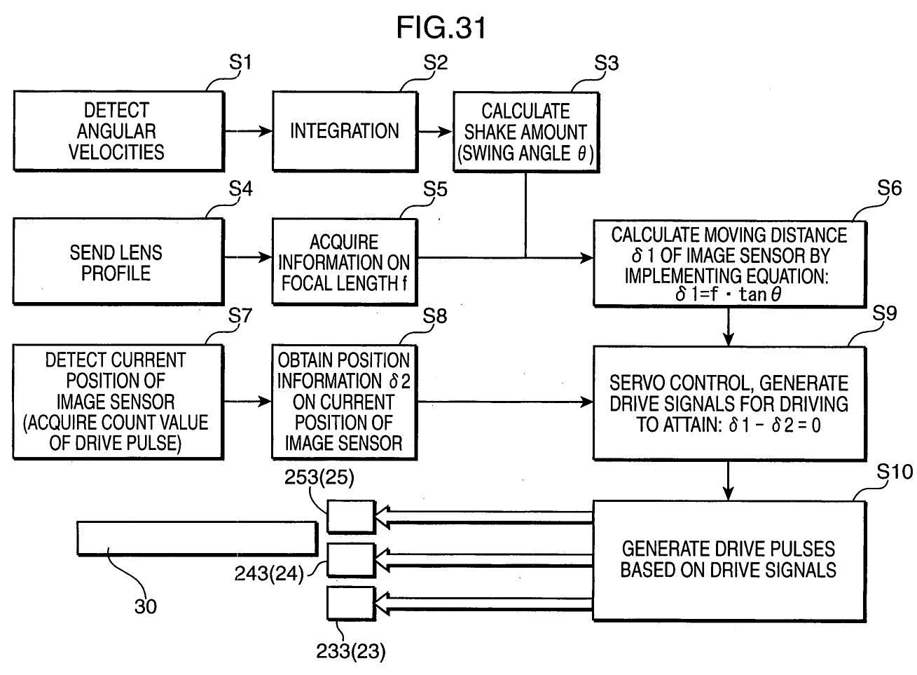

FIG. 31 is a process flow showing an anti-shake operation of the anti-shake section 91 having the above configuration. When the anti-shake processing is initiated, angular velocities of the camera body 10 in the pitch direction, the yaw direction, and the rolling direction are detected by the pitch gyro 50a, the yaw gyro 50b, and the rolling gyro 50c, respectively, based on shake of the camera body 10 (Step S1). The detected angular velocity signals are outputted to the shake detecting circuit 911 where the angular velocity signals are converted to angular signals by integration (Step S2). Then, the shake amounts (detx, dety, detz) of the camera body 10 in the pitch direction, the yaw direction, and the rolling direction, namely, a swing angle θ is obtained by the coefficient conversion circuit 912 (Step S3). The information relating to the swing angle θ is outputted to the controlling circuit 913.

The lens profile including the information relating to the focal length f stored in the lens ROM 123 of the taking lens 12 is outputted (Step S4), and the controlling circuit 913 acquires information relating to the focal length f (Step S5). The information relating to the focal length f may be acquired when the taking lens 12 is mounted on the mount portion 13, in place of being acquired at the time of anti-shake operation.

Then, the controlling circuit 913 obtains a distance δ1 by which the image, sensor 30 is to be correctively moved to cancel the shake of the camera body 10, based on the swing angle θ and the focal length f by implementing the following equation (Step S6):
δ1=f·tan θ
The distance δ1 corresponds to the moving amounts (px, py, pz) in the yaw, pitch, and rolling directions.

Then, the integration circuit 915 integrates the drive pulse numbers outputted from the driving circuit 914, and outputs the integration result to the controlling circuit 913 for acquiring the information on the current position of the image sensor 30 (Step S7). Then, the controlling circuit 913 acquires position information δ2 representing the current position of the image sensor 30, based on the integration result of the drive pulse numbers (Step S8).

The controlling circuit 913 performs servo control in response to receiving the position information δ2 (Step S9). Specifically, the controlling circuit 913 generates drive signals (drvx, drvy, drvz) for driving the pulse motors 233, 243, and 253 of the first, the second, and the third driving devices 23, 24, and 25, so that a difference between the moving distance δ1 of the image sensor 30, and the position information 82 becomes zero: (δ1−δ2=0) (Step S9). The drive signals (drvx, drvy, drvz) are outputted to the driving circuit 914, which in turn generates drive pulses for actually driving the pulse motors 233, 243, and 253.

In summary, the above arrangement makes it possible to execute pitch drive mode of moving the movable base member 22a in the pitch direction by driving the second and the third driving devices 24 and 25 based on a corrective amount of the image sensor 30 in the pitch direction, yaw drive mode of moving the movable base member 22a in the yaw direction by driving the first driving device 23 based on a corrective amount of the image sensor 30 in the yaw direction, and rolling drive mode of rotating the movable base member 22a by executing + driving or − driving of the first, the second, and the third driving devices 23, 24, and 25.

A preferred embodiment of the present invention has been described above. The present invention is not limited to the above. For instance, in the foregoing embodiment, described is a case where the first, the second, and the third driving devices 23, 24, and 25 are loaded on the fixed base member 21a. Alternatively, the first, the second, and the third driving devices 23, 24, and 25 may be loaded on the movable base member 22a. Alternatively, a so-called smooth impact type piezoelectric actuator comprising a piezo device and a driving shaft may be used in place of the first, the second, and the third driving devices 23, 24, and 25. Alternatively, it is possible to provide an actuator using a moving coil arranged in such a manner that an oscillation force is applied in two axis directions, an actuator incorporated with a small electric motor and a gear mechanism or a ball screw mechanism, an actuator using a pressure mechanism, or a like actuator on the side of a side portion of the image sensor 30.

The above embodiment has been described, by taking an example that the driving mechanism (driving system) is applied to an anti-shake mechanism of swinging an image sensor in an image sensing apparatus. The present invention is applicable to a drive control other than the anti-shake mechanism. For instance, the present invention is applicable to a driving mechanism for level shift correction. Further, the invention is applicable to a technical field of obtaining a predetermined shooting effect. For instance, in shooting stars, a long time exposure is necessary. The present invention is applicable in compensating movement of the stars arising from spinning of the earth, namely, rotating the image sensor following the movement of the stars. Further, the present invention is useful in shooting an image for special effect, wherein a blurred image is shot by intentionally rotating the image sensor during exposure.

Furthermore, the driving mechanism (driving system) is applicable to an apparatus other than the image sensing apparatus. For instance, the invention is applicable to a mechanism of moving a sample stage for microscope or a processing stage for microprocessing in x-axis direction, y-axis direction, and in rotating direction. In any case, the mechanism can be simplified and miniaturized, as compared with the conventional mechanism.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A driving mechanism comprising:
a fixed base member;
a movable base member which is movable relative to the fixed base member; and
at least three driving devices each having an operating part which is moved linearly, the three driving devices being loaded on either one of the fixed base member and the movable base member, at least three operated parts being formed on the other one of the fixed base member and the movable base member where the driving devices are not loaded to receive driving forces from the operating parts of the driving devices, respectively,
the operated parts each having a moving guide part extending in a direction of a guide axis orthogonal to a linear driving axis along which the corresponding operating part of the driving device is moved, the operating parts being guided in the respective corresponding moving guide parts to cause relative rotation of one of the movable base member and the fixed base member against the other,
at least one of the linear driving axes extending in a first direction, the other linear driving axis extending in a second direction orthogonal to the first direction, and
the respective linear driving axes extending in tangential directions of a circle having an arbitrary point on the movable base member or the fixed base member as a center point, the respective guide axes extending radially with respect to the center point.

2. The driving mechanism according to claim 1, wherein
each of the operating parts has a pin-shaped member, and
the moving guide part of each of the operated parts has a linear slot along which the pin-shaped member is slidably received.

3. The driving mechanism according to claim 1, wherein
each of the operating parts has an engaging projection, and
the moving guide part of each of the operated parts has a linear guide groove engageable with the engaging projection.

4. The driving mechanism according to claim 1, wherein
one of the three driving devices has the linear driving axis extending in the first direction, and the other two driving devices each has the linear driving axis extending in the second direction orthogonal to the first direction, and
the other two driving devices having the linear driving axes extending in the second direction are arranged parallel to each other with respect to the center point.

5. The driving mechanism according to claim 4, wherein the two driving devices having the linear driving axes extending in the second direction are arranged in a direction parallel to a direction of gravitational force if the fixed base member and the movable base member are arranged at an upright position.

6. A driving system comprising:
a driving mechanism including:
a fixed base member;
a movable base member which is movable relative to the fixed base member; and
at least three driving devices each having an operating part which is moved linearly, the three driving devices being loaded on either one of the fixed base member and the movable base member, at least three operated parts being formed on the other one of the fixed base member and the movable base member where the driving devices are not loaded to receive driving forces from the operating parts of the driving devices, respectively,
the operated parts each having a moving guide part extending in a direction of a guide axis orthogonal to a linear driving axis along which the corresponding operating part of the driving device is moved, the operating parts being guided in the respective corresponding moving guide parts to cause relative rotation of one of the movable base member and the fixed base member against the other,
at least one of the linear driving axes extending in a first direction, the other linear driving axis extending in a second direction orthogonal to the first direction, and
the respective linear driving axes extending in tangential directions of a circle having an arbitrary point on the movable base member or the fixed base member as a center point, the respective guide axes extending radially with respect to the center point;
a driven member which is mounted on the movable base member; and
a drive controller which controllably moves the operating parts of the driving devices.

7. The driving system according to claim 6, wherein the drive controller is operative to execute a first drive mode of moving the movable base member in the first direction by driving the driving device having the linear driving axis extending in the first direction, a second drive mode of moving the movable base member in the second direction by driving the driving device having the linear driving axis extending in the second direction, and a third drive mode of rotating the movable base member about an axis of rotation thereof by driving the driving device having the linear driving axis extending in the first direction, and the driving device having the linear driving axis extending in the second direction.

8. The driving system according to claim 6, wherein
each of the operating parts has a pin-shaped member, and
the moving guide part of each of the operated parts has a linear slot along which the pin-shaped member is slidably received.

9. The driving system according to claim 6, wherein
each of the operating parts has an engaging projection, and
the moving guide part of each of the operated parts has a linear guide groove engageable with the engaging projection.

10. The driving system according to claim 6, wherein
one of the three driving devices has the linear driving axis extending in the first direction, and the other two driving devices each has the linear driving axis extending in the second direction orthogonal to the first direction, and
the other two driving devices having the linear driving axes extending in the second direction are arranged parallel to each other with respect to the center point.

11. An anti-shake unit comprising:
an image sensor which converts an object light image into an electrical signal; and
a driving mechanism including:
a fixed base member;
a movable base member which is movable relative to the fixed base member; and
at least three driving devices each having an operating part which is moved linearly, the three driving devices being loaded on either one of the fixed base member and the movable base member, at least three operated parts being formed on the other one of the fixed base member and the movable base member where the driving devices are not loaded to receive driving forces from the operating parts of the driving devices, respectively,
the operated parts each having a moving guide part extending in a direction of a guide axis orthogonal to a linear driving axis along which the corresponding operating part of the driving device is moved, the operating parts being guided in the respective corresponding moving guide parts to cause relative rotation of one of the movable base member and the fixed base member against the other,
at least one of the linear driving axes extending in a first direction, the other linear driving axis extending in a second direction orthogonal to the first direction, and
the respective linear driving axes extending in tangential directions of a circle having an arbitrary point on the movable base member or the fixed base member as a center point, the respective guide axes extending radially with respect to the center point,
wherein the image sensor is mounted on the movable base member as a driven member.

12. The anti-shake unit according to claim 11, wherein
each of the operating parts has a pin-shaped member, and
the moving guide part of each of the operated parts has a linear slot along which the pin-shaped member is slidably received.

13. The anti-shake unit according to claim 11, wherein
each of the operating parts has an engaging projection, and
the moving guide part of each of the operated parts has a linear guide groove engageable with the engaging projection.

14. The anti-shake unit according to claim 11, wherein
one of the three driving devices has the linear driving axis extending in the first direction, and the other two driving devices each has the linear driving axis extending in the second direction orthogonal to the first direction, and
the other two driving devices having the linear driving axes extending in the second direction are arranged parallel to each other with respect to the center point.

15. An image sensing apparatus comprising:
an anti-shake unit including:
a driving mechanism including:
a fixed base member;
a movable base member which is movable relative to the fixed base member; and
at least three driving devices each having an operating part which is moved linearly, the three driving devices being loaded on either one of the fixed base member and the movable base member, at least three operated parts being formed on the other one of the fixed base member and the movable base member where the driving devices are not loaded to receive driving forces from the operating parts of the driving devices, respectively,
the operated parts each having a moving guide part extending in a direction of a guide axis orthogonal to a linear driving axis along which the corresponding operating part of the driving device is moved, the operating parts being guided in the respective corresponding moving guide parts to cause relative rotation of one of the movable base member and the fixed base member against the other,
at least one of the linear driving axes extending in a first direction, the other linear driving axis extending in a second direction orthogonal to the first direction, and
the respective linear driving axes extending in tangential directions of a circle having an arbitrary point on the movable base member or the fixed base member as a center point, the respective guide axes extending radially with respect to the center point; and
an image sensor which converts an object light image into an electrical signal, the image sensor being mounted on the movable base member as a driven member; a shake detector which detects angular velocities of a main body of the image sensing apparatus in a pitch direction, in a yaw direction, and in a rolling direction based on a shake applied to the apparatus main body;
a corrective amount calculator which calculates corrective amounts by which the apparatus main body is to be correctively moved in the pitch direction, in the yaw direction, and in the rolling direction to cancel the shake of the apparatus main body, based on detection results of the shake detector; and
a drive controller which controls the driving devices to correctively move the operating parts thereof in the pitch direction, in the yaw direction, and in the rolling direction, depending on the corrective amounts calculated by the corrective amount calculator.

16. The image sensing apparatus according to claim 15, wherein
the first direction and the second direction of the linear driving axes correspond to the pitch direction and the yaw direction, respectively, or the yaw direction and the pitch direction, respectively;
the drive controller is operative to execute a pitch drive mode of correctively moving the movable base member in the pitch direction by driving the, driving device having the linear driving axis extending in the direction along the pitch direction based on the corrective amount in the pitch direction, and a yaw drive mode of correctively moving the movable base member in the yaw direction by driving the driving device having the linear driving axis extending in the direction along the yaw direction based on the corrective amount in the yaw direction; and
the drive controller is operative to execute a rolling drive mode of rotating the movable base member about an axis of rotation thereof by driving the driving device having the linear driving axis extending in the first direction, and the driving device having the linear driving axis extending in the second direction.

17. The image sensing apparatus according to claim 15, wherein
each of the operating parts has a pin-shaped member, and
the moving guide part of each of the operated parts has a linear slot along which the pin-shaped member is slidably received.

18. The image sensing apparatus according to claim 15, wherein
each of the operating parts has an engaging projection, and
the moving guide part of each of the operated parts has a linear guide groove engageable with the engaging projection.

19. The image sensing apparatus according to claim 15, wherein
one of the three driving devices has the linear driving axis extending in the first direction, and the other two driving devices each has the linear driving axis extending in the second direction orthogonal to the first direction, and
the other two driving devices having the linear driving axes extending in the second direction are arranged parallel to each other with respect to the center point.
